(19) United States
(12) Patent Application Publication
(10) Pub. No.: US 2003/0134238 A1
(43) Pub. Date: Jul. 17, 2003

(54) Photothermographic material

(75) Inventor: Yasuhiro Yoshioka, Minami Ashigara-shi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/272,986

(22) Filed: Oct. 18, 2002

(30) Foreign Application Priority Data
Oct. 18, 2001 (JP) P.2001-320550

(51) Int. Cl. G03C 1/498; G03C 1/76

(52) U.S. Cl. 430/620; 430/950

(57) ABSTRACT

A photothermographic material comprising: a reflective support; a photosensitive silver halide; a non-photosensitive organic silver salt; a reducing agent for silver ions; a binder; and an organic polyhalogen compound.

### FIELD OF THE INVENTION

The present invention relates to photothermographic materials (heat-developable photosensitive materials), particularly to photothermographic materials formed on a reflective support and suited for use in the output of digital images for medical use.

### BACKGROUND OF THE INVENTION

In recent years, a reduction in the amount of waste liquids after processing is strongly desired in the medical field from the standpoints of environmental protection and space savings. There is therefore a demand for the technique relating to photosensitive heat-developable photographic materials for use in medical diagnosis and photographic art permitting efficient exposure by a laser image setter or a laser imager and formation of a clear black image having high resolution and sharpness. Such photosensitive heat-developable photographic materials can provide users with a heat development system that does not need a solution-type processing chemical, is simple and does not pollute the environment.

Requests are similar in the field of ordinary image-forming materials. Photo-images for medical use however need to be minute so that high image quality excellent in sharpness and graininess is necessary. In addition, cold tone images which facilitate diagnosis are preferred. Various hard copy systems utilizing a pigment or dye, for example, ink jet printers and electrophotography are popular as ordinary image forming systems. They are however not satisfactory as an output system of images for medical use.

Heat-developable image forming systems utilizing an organic silver salt are described, for example, in U.S. Pat. Nos. 3,152,904 and 3,457,075 and B. Shely, “Thermally Processed Silver Systems (“Imaging Processes and Materials)”, Neblette, 8th ed., compiled by J. Sturge, V. Walworth and A. Shepp, p. 2, (1966). In particular, photothermographic materials have a photosensitive layer having, dispersed in the matrix of the binder thereof, a catalytically active amount of a photocatalyst (ex. silver halide), a reducing agent, and a reducible silver salt (ex. organic silver salt) and if necessary, a toning agent for controlling the tone of a silver color. When the photothermographic materials are heated at a high temperature (e.g., 80° C. or higher) after exposure, a black silver image is produced through an oxidation-reduction reaction between the silver halide or the reducible silver salt (which functions as an oxidizing agent) and the reducing agent. The oxidation-reduction reaction is accelerated by the catalytic action of a latent image of the silver halide generated upon exposure. Therefore, the black silver images are formed in exposed areas. This technique is disclosed in many references including U.S. Pat. No. 2,910,377 and Japanese Patent Publication No. 4924/1968, and based on it, Fuji Medical Dry Imager “FM-DP L” is put on the market as a medical image forming system using a photothermographic material.

In the medical field, the above-described photothermographic materials have so far been used mainly for the diagnostic imaging and the images on a transmitting film have been observed on a Schaukasten. With a recent progress in digitalization of images in the medical field, many image data must be observed simultaneously. In addition, as “informed consent” becomes popular, there presumably appears a latent need among doctors and patients to observe medical images without using a Schaukasten whenever, wherever.

To satisfy the above-described request, reflective materials are better than transparent materials. Only an inkjet printer is available as reflective image output means and means for outputting high-quality images conveniently in a short time has not yet been provided.

### SUMMARY OF THE INVENTION

An object of the present invention is therefore to provide a reflective type photothermographic material permitting easy output of high quality reflective images.

The above-described object has been attained by the following photothermographic materials.

1. A photothermographic material comprising, on a reflective support, at least one photosensitive silver halide, non-photosensitive organic silver salt, reducing agent for silver ions and binder, said photothermographic material further comprising at least one organic polyhalogen compound.

2. A photothermographic material described above in 1, wherein the organic polyhalogen compound is represented by the following formula (H):

Q—(Y)ₙ—(CZ₁)(Z₂)X (H)

wherein, Q represents an alkyl, aryl or heterocyclic group, Y represents a divalent linking group, n stands for 0 or 1, Z₁ and Z₂ each represents a halogen atom, and X represents a hydrogen atom or an electron-withdrawing group.

3. A photothermographic material described above in 1 or 2, wherein the reducing agent is represented by the following formula (R):

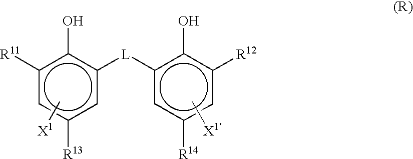

wherein, R¹¹ and R¹² each independently represents an alkyl group, R¹³ and R¹⁴ each independently represents an alkyl group, L represents an —S— or —CR¹⁵— group, in which R¹⁵ represents a hydrogen atom or an alkyl group, X¹ and X^{1′} each independently represents a hydrogen atom or a group substitutable for a benzene ring.

4. A photothermographic material described above in 3, wherein in the formula (R), R¹¹ and R¹² each independently represents a secondary or tertiary alkyl group, R¹³ and R¹⁴ each independently represents an alkyl group, L represents a —CR¹⁵— group, in which R¹⁵ represents a hydrogen atom or an alkyl group.

5. A photothermographic material described above in any one of 1 to 4, further comprising, on the side of the support on which the reducing agent exists, a compound capable of forming a hydrogen bond with an NH group or an OH group.

6. A photothermographic material described above in 5, wherein the compound capable of forming a hydrogen bond is represented by the following formula (D):

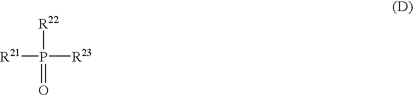

wherein, R²¹, R²² and R²³ each independently represents an alkyl, aryl, heterocyclic, alkoxy, aryloxy or amino group.

7. A photothermographic material described above in any one of 1 to 6, further comprising, on the side of the support on which the reducing agent exists, a hydrazine compound.

8. A photothermographic material described above in 7, wherein the hydrazine compound is represented by the following formula (A):

R³¹—NHNHCONH—R³² (A)

wherein, R³¹ represents an aryl or heterocyclic group and R³² represents an alkyl, aryl, heterocyclic or amino group.

9. A photothermographic material described above in any one of 1 to 8, further comprising, on the side of the support on which the reducing agent exists, a mercapto-containing heterocyclic compound.

10. A photothermographic material described above in any one of 1 to 9, wherein the coating quantity of silver is 1.0 g/m² or less.

11. A photothermographic material described above in any one of 1 to 10, wherein the coating quantity of the reducing agent is 2.0 mmol/m² or less.

12. A photothermographic material described above in any one of 1 to 11, wherein the heat development time ranges from 1 to 12 seconds.

### DETAILED DESCRIPTION OF THE INVENTION

The present invention will hereinafter be described specifically.

(Support)

First, the reflective support of the present invention will be described.

As the support for use in the present invention, any reflective support is usable insofar as a photographic emulsion layer can be applied to it, for example, glass, paper and plastic film. Preferred is a plastic film or a paper support coated with a resin. The term “reflective support” used in the present invention means one which increases reflectivity and makes sharp a dye image formed in a silver halide emulsion layer. Examples of such a reflective support include supports covered by a hydrophobic resin having dispersed therein a light-reflective substance such as titanium oxide, zinc oxide, calcium carbonate or calcium sulfate and supports made of a hydrophobic resin having dispersed therein a light-reflective substance. Specific examples include polyethylene coated paper, polyethylene-terephthalate-coated paper, polypropylene-series synthetic paper and supports obtained by forming a reflective layer on an essentially transparent support such as glass plate, polyethylene terephthalate, cellulose triacetate, cellulose nitrate, polyester film, polyamide film, polycarbonate film, polystyrene film or polyvinyl chloride resin, or by making the support reflective with a reflective substance incorporated therein. A particularly preferred reflective support in the present invention is a paper support covered, at both sides thereof, with heat resistant resin layers, at least one of the heat resistant resin layers containing white pigment particles.

The water resistant resin usable for the reflective support in the present invention is a resin having a water absorption (% by mass) of 0.5, preferably not greater than 0.1. Examples of the water resistant resin include polyolefins such as polyethylene, polypropylene, a polyethylene series polymer; a vinyl polymer and the copolymers thereof (e.g., polystyrene, polyacrylate, and the copolymers thereof), polyesters (polyethylene terephthalate, polyethylene isophthalate) and the copolymers thereof. Polyethylene and polyesters are particularly preferred;

As the polyethylene, high density polyethylene, low density polyethylene, or linear low density polyethylene, or a mixture thereof is usable. The melt flow rate (which will hereinafter be abbreviated as “MFR”) of the polyethylene resin before processing preferably ranges from 1.2 g/10 min to 12 g/10 min as measured in accordance with JISK 7210 under the conditions 4 in Table 1. The term “MFR of the polyolefin resin before processing” as used herein means MRF of the resin before mixing with a bluing agent or white pigment.

As the polyester, that synthesized by condensation polymerization of a dicarboxylic acid and a diol is preferred. Preferred examples of the dicarboxylic acid include terephthalic acid, isophthalic acid and naphthalenedicarboxylic acid, while those of the diol include ethylene glycol, butylene glycol, neopentyl glycol, triethylene glycol, butanediol, hexylene glycol, bisphenol A ethylene oxide adduct (2,2-bis(4-(2-hydroxyethyloxy)phenyl)propane) and 1,4-dihydroxymethylcyclohexane.

A variety of polyesters available by condensation polymerization of at least one of these dicarboxylic acids and at least one of these diols. At least one of the dicarboxylic acids is preferably terephthalic acid. A 9:1 to 2:8 mixture of terephthalic acid and isopthalic acid or a 9:1 to 2:8 mixture of terephthalic acid and naphthalenedicarboxylic acid is also preferably employed as the dicarboxylic acid component. As the diol, ethylene glycol or a mixed diol containing ethylene glycol is preferred. Such a polymer preferably has a molecular weight of 30000 to 50000.

A mixture of a plurality of polyesters different in composition is also preferred. A mixture of such a polyester with another resin is also preferred. The another resin to be mixed with the polyester can be selected from many resins which can be extruded at 270 to 350° C. and examples include polyolefins such as polyethylene and polypropylene, polyethers such as polyethylene glycol, polyoxymethylene and polyoxypropylene, polyester polyurethane, polyether polyurethane, polycarbonate and polystyrene. The resins to be mixed may be used either singly or in combination. For example, 90% by mass of polyethylene terephthalate can be mixed with 6% by mass of polyethylene and 4% by mass of polypropylene. Although a mixing ratio varies depending on the kind of the resin to be mixed with polyester, a weight ratio of polyester/the another resin may range from 100/0 to 80/20 when the another resin is a polyolefin. Weight ratios exceeding the above-described range cause a drastic deterioration in the physical properties of the mixed resin. When the another resin is other than polyolefin, a weight ratio of polyester/the another resin may range from 100/0 to 50/50.

A mixing ratio (weight ratio) of the water-resistant resin with a white pigment ranges from 98/2 to 30/70 (heat-resistant resin/white pigment), preferably 95/5 to 50/50, especially 90/10 to 60/40. When the ratio of the white pigment is less than 2% by mass, its contribution to whiteness is insufficient. When the ratio exceeds 70% by mass, on the other hand, the resulting photographic support has insufficient surface smoothness, making it impossible to obtain a photographic support excellent in glossiness.

The water-resistant resin is preferably laid over a substrate with a thickness of 2 to 200 μm, preferably 5 to 80 μm. Thickness exceeding 200 μm makes the fragility of the resin prominent, presumably leading to problems of physical properties such as crack of the film. When the thickness is less than 2 μm, on the other hand, water proofing property, which is the original object of coating, is impaired, both whiteness and surface smoothness cannot be attained, and the film becomes too soft and shows a deterioration in physical properties. The thickness outside the above-described range is therefore not preferred.

The resin or resin composition to be coated on a side of the substrate over which a photosensitive layer is not laid preferably has a thickness of 5 to 100 μm, more preferably 10 to 50 μm. Thickness exceeding this range makes the fragility of the resin prominent, presumably leading to problems of physical properties such as film cracks. Thickness less than this range, on the other hand, not only impairs the water proofing property, which is the original object of the coating, but also makes the film too soft, thus deteriorating physical properties. The thickness outside the above-described range is therefore not preferred.

From the viewpoint of cost and manufacturing aptitude of the support, it is sometimes preferred that the reflective support for use in the present invention has, as a water resistant resin coating layer on the photosensitive layer coated side thereof, a plurality of water resistant resin coating layers different in the content of a white pigment. In such a case, among the water resistant resin coating layers different in the content of a white pigment, the content of the white pigment of the water resistant resin coating layer nearest to the substrate is preferably lower than that of at least one water resistant resin coating layer thereabove. The more preferred one is a reflective support whose water resistant resin coating layer nearest to the photosensitive layer has, among multiple water resistant resin coating layers different in a white pigment content, a highest white pigment content; or a reflective support having, on one side thereof, at least three water resistant resin coating layers and having a highest white pigment content in any intermediate layer other than the water resistant resin coating layer nearest to the photosensitive layer and the water resistant resin coating layer nearest to the substrate.

The white pigment content of each layer of the multiple water resistant resin layers ranges from 0 to 70% by mass, preferably 0 to 50% by mass, more preferably 0 to 40% by mass. The white pigment content of the layer having a highest white pigment content, among these multiple water resistant resin layers, ranges from 9 to 70% by mass, preferably 15 to 50% by mass, more preferably 20 to 40% by mass. When the white pigment content of this layer is less than 9% by mass, the sharpness of the image is low, while when it exceeds 70% by mass, cracks appear in the melt extruded film.

The thickness of each layer of the multiple water resistant resin layers preferably ranges from 0.5 to 50 μm. When the multiple water resistant resin layers have two layers, the thickness of each layer preferably ranges from 0.5 to 50 μm. The total thickness of these layers preferably falls within the above-described range (2 to 200 μm). When the multiple water resistant resin layers have three layers, it is preferred that the uppermost layer has a film thickness of from 0.5 to 10 μm, the middle layer has a film thickness of from 5 to 50 μm, and the lowest layer (nearest to the substrate) has a film thickness of from 0.5 to 10 μm. At the film thickness of the uppermost or lowest layer less than 0.5 μm, die lip stripes tend to appear owing to the action of the highly filled white pigment of the middle layer. The thickness of the uppermost layer or the lowest layer, particularly the uppermost layer exceeding 10 μm, on the other hand, lowers sharpness.

The white pigment fine particles are preferably dispersed uniformly without forming an aggregate thereof in the reflective layer. The distribution size can be determined by measuring the space percentage (%) (Ri) of the fine particles projected onto a unit area. The coefficient of variation of the space percentage (%) can be determined from a ratio s/R, that is, a ratio of standard deviation (s) of Ri to the mean value (R) of Ri. In the present invention, the coefficient of variation of the space percentage (%) of fine pigment particles is preferably 0.15 or less, more preferably 0.12 or less, especially 0.08 or less.

In the present invention, a support surface preferably has secondary diffuse reflectivity. The term “secondary diffuse reflectivity” means diffuse reflectivity attained by roughening a mirror surface and dividing it into mirror surface pieces facing minutely different directions, thereby dispersing the directions of the minute surfaces (mirror surfaces) thus divided. The unevenness on the secondary diffuse reflective surface has a three-dimensional average roughness of from 0.1 to 2 μm, preferably from 0.1 to 1.2 μm, relative to the center surface. The frequency of the surface unevenness is preferably 0.1 to 2000 cycles/mm, more preferably from 50 to 600 cycles/mm when the unevenness has roughness of 0.1 μm or greater. Details of such a support are described in Japanese Patent Laid-Open No. 239244/1990.

A resin coated paper support preferred in the present invention is a paper support coated with a titanium-oxide-containing polyester resin which is described in Japanese Patent Laid-Open No. 202295/1994.

The plastic support preferred in the present invention is a polyester film having whiteness improved by scattering light by the white pigment, non-compatible resin, and minute voids.

The term “polyester” in the polyester film is, in the present invention, a generic term of high molecules having an ester bond as a main bonding chain of its main chain. Preferred examples of the polyester include high molecules having, as a main component, at least one component selected from ethylene terephthalate, ethylene-2,6-naphthalate, butylene terephthalate, ethylene-α,β-bis(2-chlorophenoxy)ethane-4,4′-dicarboxylate, ethylene-α,β-bis(phenoxy)ethane-4,4′-dicarboxylate units. These components may be used either singly or in combination. Among them, polyester having, as a main component, ethylene terephthalate is particularly preferred based on the synthetic judgment of its quality and economy. More preferred is polyethylene-2,6-naphthalatee having excellent heat resistance and rigidity.

Such a polyester may be copolymerized partially, preferably in an amount of 20 mol % or less, with another dicarboxylic acid component or diol component.

In addition, such a polyester may contain another polymer or various known additives such as antioxidant, heat resistance stabilizer, weather resistance stabilizer, lubricant, ultraviolet absorber, pigment, dye, organic or inorganic fine particles, filler, antistatic and nucleating agent in an extent not deteriorating the properties of the support.

Although no particular limitation is imposed on the white polyester film usable in the present invention, that having an optical density of 0.5 or greater and a whiteness degree of 80% or greater is preferred. That having a whiteness degree of from 85 to 150%, preferably from 90 to 130% and an optical density of from 0.9 to 5, preferably from 1.2 to 3 is particularly preferred.

Although no particular limitation is imposed on the method of attaining such optical density and whiteness degree, it can usually be actualized by the addition of inorganic particles or a resin incompatible with polyester. The content of the inorganic particles or the resin is not particular limited, but the preferred content is from 5 to 35% by mass, preferably from 8 to 25% by mass in the former case and from 5 to 35 vol. %, preferably from 8 to 25 vol. % in the latter case.

Although no particular limitation is imposed on the inorganic particles usable in the present invention, those having an average particle size of from 0.1 to 4 μm, preferably from 0.3 to 1.5 μm can be used as a typical example. Specific examples include barium sulfate, calcium carbonate, calcium sulfate, titanium oxide, silica, alumina, talc and clay, and mixtures thereof. These inorganic particles may be used in combination with another inorganic compound such as calcium phosphate, mica, zirconia, tungsten oxide, lithium fluoride and calcium fluoride. Use of the above-described inorganic particles having a Mohs hardness of 5 or less, preferably 4 or less is more preferred, because it improves a whiteness degree.

Although no particular limitation is imposed on the resin incompatible with polyester, examples include, when the polyester is polyethylene terephthalate or polyethylene-2,6-naphthalate, acrylic resins, polyethylene, polypropylene, polymethylpentene, modified olefin resins, polybutylene terephthalate resins, phenoxy resins and polyphenylene oxide. Such a resin may be used in combination with the above-described inorganic particles. In particular, a white polyester film prepared by biaxial stretching of a mixture with the inorganic particles and/or the resin incompatible with the polyester, thereby having voids inside and having a specific gravity of 0.5 to 1.3 g/cm³ is preferred for its good printability.

The white polyester film of the present invention is preferably a biaxially oriented polyester film when it has a laminate film disposed thereon. The term “biaxially oriented polyester film” means a film which has been obtained by stretching a polyester sheet or film, which has not been stretched yet, to a draw ratio of from 2.5 to 5 both in the machine direction and transverse direction, followed by heat treatment to complete crystal orientation; and exhibits biaxially oriented patterns as a result of wide-angle X-ray diffraction.

Although no particular limitation is imposed on the thickness of the white polyester film, it is preferably 5 to 1000 μm, preferably 75 to 500 μm in consideration of its using purpose. A plurality of the films thus obtained are adhered each other to give a desired thickness.

The white plastic film used in the present invention for the above-described purpose is described in detail in Japanese Patent Laid-Open No. 71074/1997. The plastic films described in this patent are preferred in the present invention.

In particular, a polyethylene terephthalate film or polyethylene-2,6-naphthalate film having titanium oxide incorporated therein is preferred.

(Polyhalogen Compound)

The polyhalogen compound for use in the present invention is a compound containing at least two halogen atoms in the molecule thereof and can prevent fogging by releasing therefrom halogen atoms upon heat development. This polyhalogen compound can also prevent fogging which otherwise occurs upon storage of untreated photothermographic material or occurs with the passage of time after processing.

The organic polyhalogen compound preferred in the present invention will next be described specifically. The polyhalogen compound preferred in the present invention is represented by the following formula (H):

Q—(Y)ₙ—C(Z₁)(Z₂)X (H)

wherein, Q represents an alkyl, aryl or heterocyclic group, Y represents a divalent linking group, n represents 0 or 1, Z₁ and Z₂ each represents a halogen atom, and X represents a hydrogen atom or an electron-withdrawing group.

In formula (H), Q preferably represents a phenyl group substituted by an electron-withdrawing group-having a Hammett substituent constant σp of a positive value. The Hammett substituent constant is described, for example, in Journal of Medicinal Chemistry, 16(11), 1207-1216(1973). Examples of such an electron-withdrawing group include halogen atoms (e.g., fluorine (σp: 0.06), chlorine (σp: 0.23), bromine (σp: 0.23), iodine (σp: 0.18)), trihalomethyl groups (e.g., tribromomethyl (σp: 0.29), trichloromethyl (σp: 0.33), trifluoromethyl (σp: 0.54)), a cyano group (σp: 0.66), a nitro group (σp: 0.78), aliphatic.aryl or heterocyclic sulfonyl groups (e.g., methanesulfonyl (σp: 0.72)), aliphatic.aryl or heterocyclic acyl groups (e.g., acetyl (σp: 0.50), benzoyl (σp: 0.43)), alkynyl groups (e.g., C≡CH (σp: 0.23)), aliphatic.aryl or heterocyclic oxycarbonyl groups (e.g., methoxycarbonyl (σp: 0.45), phenoxycarbonyl (σp: 0. 44)), a carbamoyl group (σp: 0.36), a sulfamoyl group (σp: 0.57), a sulfoxide group, a heterocyclic group and a phosphoryl group. The σp value preferably ranges from 0.2 to 2.0, more preferably from 0.4 to 1.0. Particularly preferred examples of the electron-withdrawing group include carbamoyl group, alkoxycarbonyl groups, alkylsulfonyl groups and alkylphosphoryl groups. Of these, a carbamoyl group is most preferred.

X is preferably an electron-withdrawing group. More preferred examples include halogen atoms, aliphatic.aryl or heterocyclic sulfonyl groups, aliphatic.aryl or heterocyclic acyl groups, aliphatic.aryl or heterocyclic oxycarbonyl groups, a carbamoyl group and a sulfamoyl group. Of these, halogen atoms are particularly preferred. Of these halogen atoms, chlorine, bromine and iodine are preferred, of which chlorine and bromine are more preferred, with bromine being particularly preferred.

Y preferably represents —C(═O)—, —SO— or —SO₂—, more preferably —C(═O)— or —SO₂—, especially —SO₂—. The letter n represents 0 or 1, preferably 1.

Specific examples of the compound represented by formula (H) for use in the present invention are set forth below.

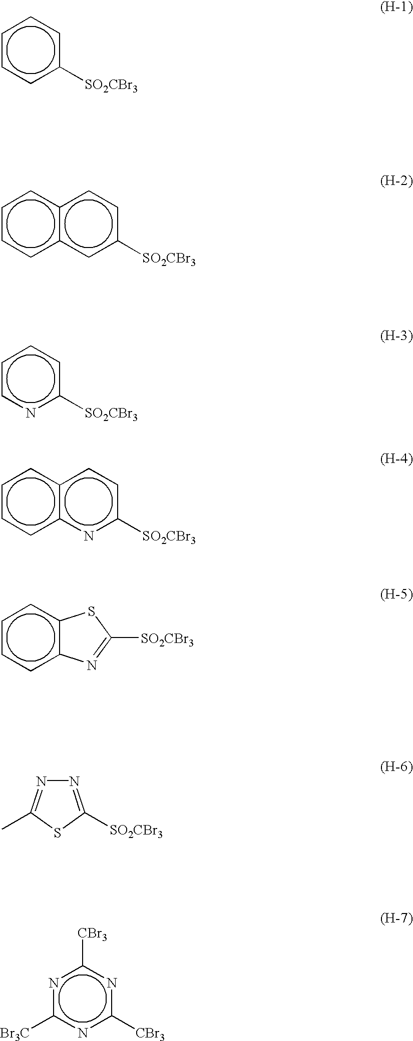

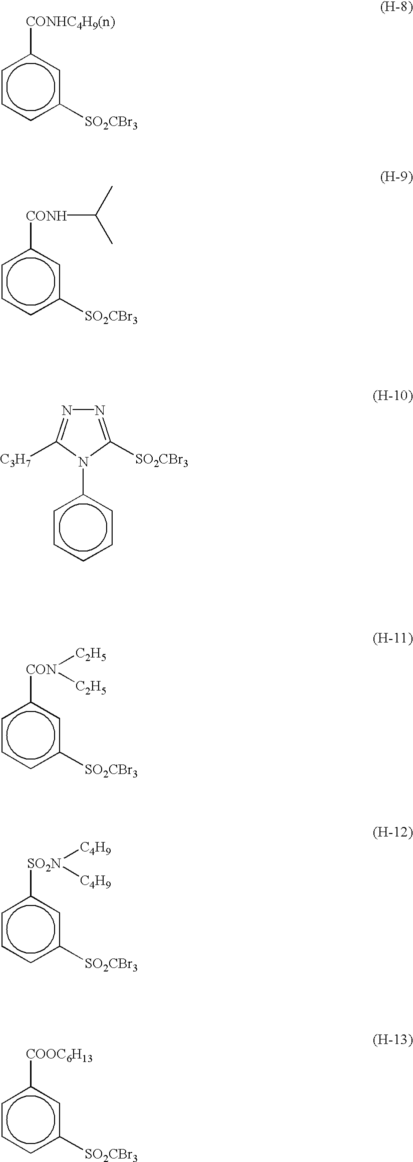

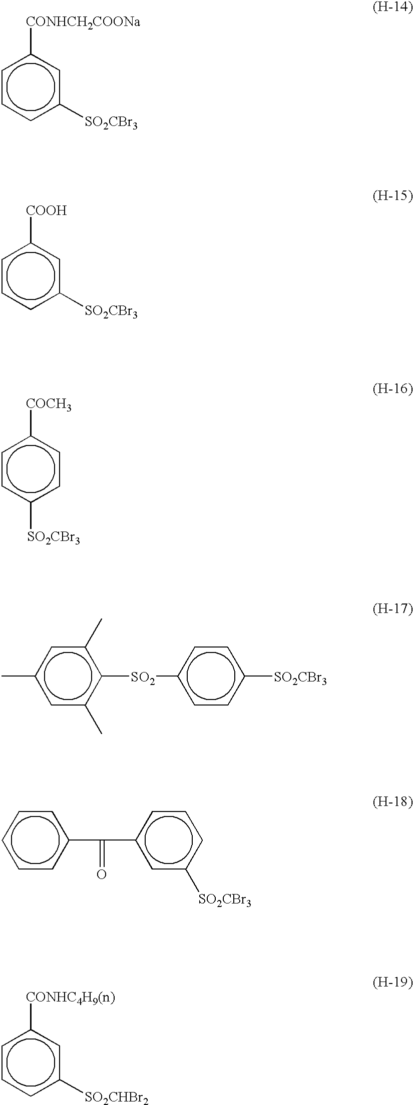

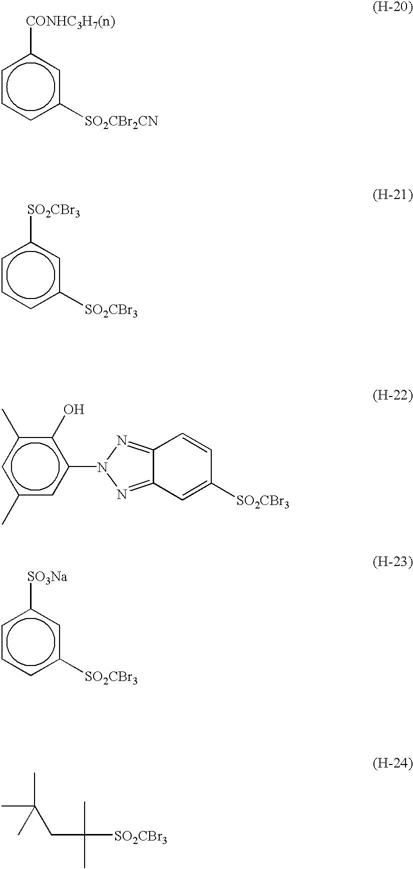

The compound of the present invention represented by formula (H) is preferably used in an amount of from 10⁻⁴ to 1 mol, more preferably from 10⁻³ to 0.5 mol, still more preferably from 1×10⁻² to 0.2 mol, per mol of the non-photosensitive silver salt in the image forming layer.

In the present invention, for incorporating an antifoggant in the photothermographic material, the method employed for incorporation of a reducing agent, which will be described later, may be used. The organic polyhalogen compound is also preferably added in the form of a solid fine particle dispersion.

(Reducing Agent)

The photothermographic material of the present invention preferably contains a heat developer serving as a reducing agent for an organic silver salt. The reducing agent for the organic silver salt may be any substance (preferably an organic substance) capable of reducing silver ions into metal silver. Such a reducing agent is described in Japanese Patent Laid-Open No. 65021/1999 (paragraph Nos. 0043 to 0045) and European Patent Laid-Open No. 0803764A1 (page 7, line 34 to page 18, line 12).

In the present invention, the reducing agent is preferably a so-called hindered phenol reducing agent or bisphenol reducing agent, having, a substituent at the ortho position of the phenolic hydroxyl group, more preferably a compound represented by the below-described formula (R).

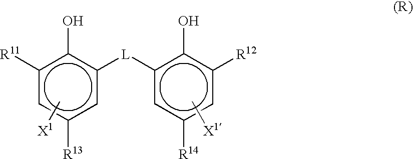

wherein R¹¹ and R¹² each independently represents a C₁₋₂₀ alkyl group; R¹³ and R¹⁴ each independently represents a hydrogen atom or a substituent capable of substituting to the benzene ring; L represents an —S— or —CHR¹⁵— group; R¹⁵ represents a hydrogen atom or a C₁₋₂₀ alkyl group; and X¹ and X^{1′} each independently represents a hydrogen atom or a group capable of substituting to the benzene ring.

A description will next be made of the formula (R) in detail.

R¹¹ and R¹² each independently represents a substituted or unsubstituted C₁₋₂₀ alkyl group. The substituent for the alkyl group is not particularly limited but preferred examples include aryl groups, a hydroxyl group, alkoxy groups, aryloxy groups, alkylthio groups, arylthio groups, acylamino groups, a sulfonamide group, a sulfonyl group, a phosphoryl group, acyl groups, a carbamoyl group, ester groups, a ureido group, a urethane group and halogen atoms.

R¹³ and R¹⁴ each independently represents a hydrogen atom or a substituent capable of substituting to the benzene ring, and X¹ and X^{1′} each independently represents a hydrogen atom or a group capable of substituting to the benzene ring. Preferred examples of these groups capable of substituting to the benzene ring include alkyl groups, aryl groups, halogen atoms, alkoxy groups and acylamino groups.

L represents a group —S— or —CHR¹³—. R¹⁵ represents a hydrogen atom or a C₁₋₂₀ alkyl group and the alkyl group may have a substituent. Specific examples of the unsubstituted alkyl group represented by R¹⁵ include a methyl group, an ethyl group, a propyl group, a butyl group, a heptyl group, a undecyl group, an isopropyl group, a 1-ethylbenzyl group and a 2,4,4-trimethylpentyl group. Examples of the substituent for the alkyl group are similar to those for R¹¹.

R¹¹ and R¹² each preferably represents a secondary or tertiary C₃₋₁₅ alkyl group and specific examples include an isopropyl group, an isobutyl group, a t-butyl group, a t-amyl group, a t-octyl group, a cyclohexyl group, a cyclopentyl group, a 1-methylcyclohexyl group and a 1-methylcyclopropyl group. R¹¹ and R¹² each is preferably a tertiary C₄₋₁₂ alkyl group, more preferably a t-butyl group, a t-amyl group or a 1-methylcyclohexyl group, most preferably a t-butyl group.

R¹³ and R¹⁴ each preferably represents a C₁₋₂₀ alkyl group and specific examples include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group and a methoxyethyl group. Of these, more preferred are a methyl group, an ethyl group, a propyl group, an isopropyl group and a t-butyl group. X¹ and X^{1′} are each preferably a hydrogen atom, a halogen atom or an alkyl group, more preferably a hydrogen atom.

L is preferably a group —CHR¹⁵—.

R¹⁵ is preferably a hydrogen atom or a C₁₋₁₅ alkyl group and preferred examples of the latter include a methyl group, an ethyl group, a propyl group, an isopropyl group or a 2,4,4-trimethylpentyl group. As R¹⁵, particularly preferred is a hydrogen atom, a methyl group, a propyl group or an isopropyl group.

When R¹⁵ is a hydrogen atom, R¹³ and R¹⁴ are each preferably a C₂₋₅ alkyl group, more preferably an ethyl group or a propyl group, most preferably an ethyl group. When R¹⁵ is a primary or secondary C₁₋₈ alkyl group, R¹³ and R¹⁴ are each preferably a methyl group. As the primary or secondary C₁₋₈ alkyl group represented by R¹⁵, more preferred is a methyl group, an ethyl group, a propyl group or an isopropyl group, with a methyl group, an ethyl group or a propyl group being still more preferred.

When R¹¹, R¹², R¹³ and R¹⁴ are all a methyl group, R¹⁵ is preferably a secondary alkyl group. In this case, the secondary alkyl group represented by R¹⁵ is preferably an isopropyl group, an isobutyl group or a 1-ethylpentyl group, more preferably an isopropyl group.

The above-described reducing agent differs in heat developability and developed silver color tone, depending on what are used in combination as R¹¹, R¹², R¹³, R¹⁴ and R¹⁵. The above-described properties can be controlled by the use of at least two reducing agents in combination, so it is preferred to do so, though depending on the purpose.

Specific examples of the reducing agent for use in the present invention including the compounds represented by the formula (R) are set forth below, however, the present invention is not limited thereto.

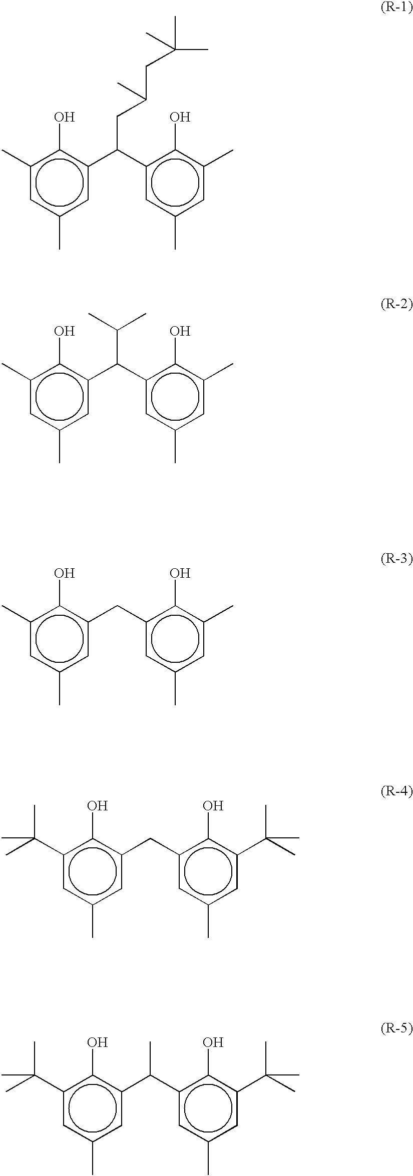

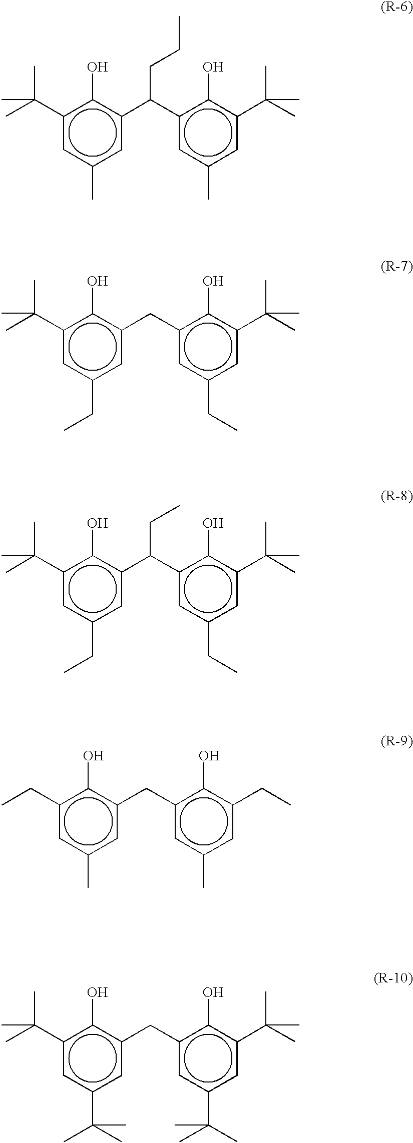

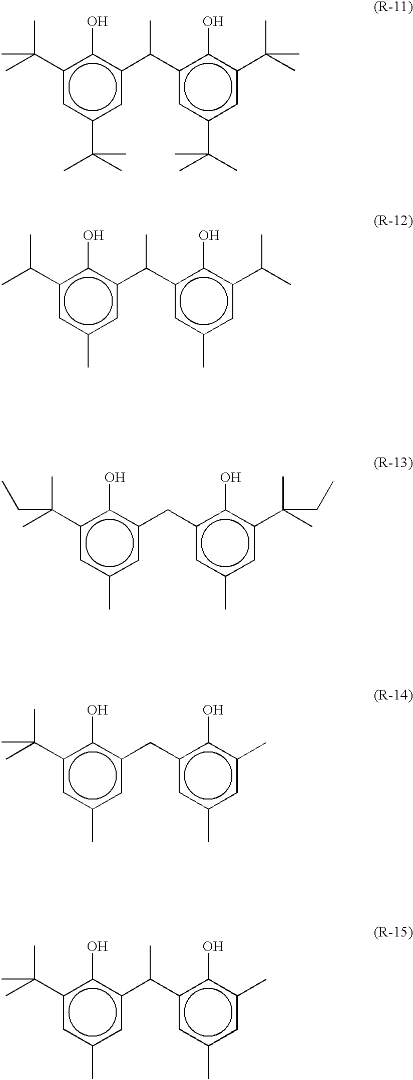

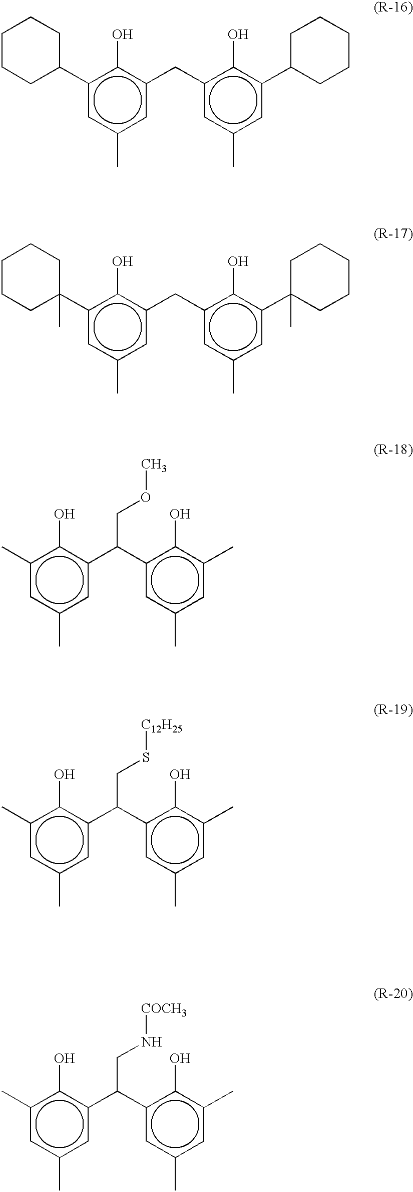

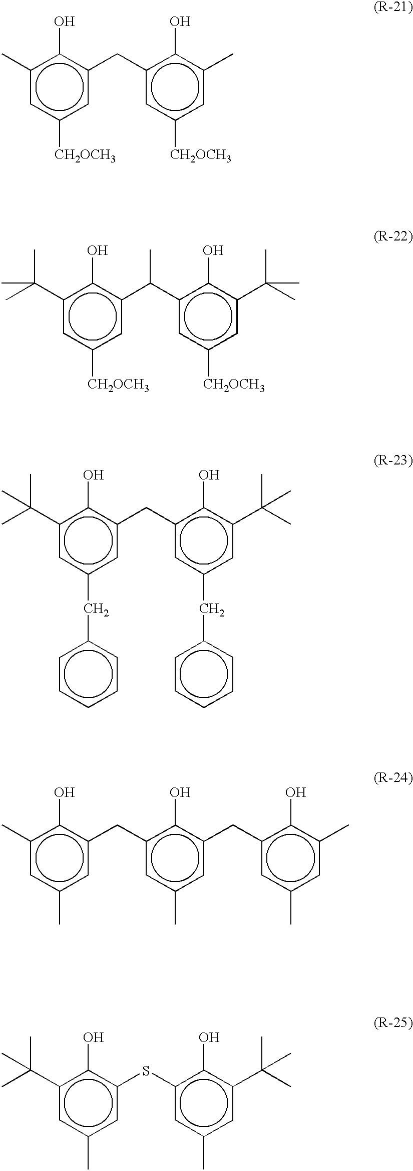

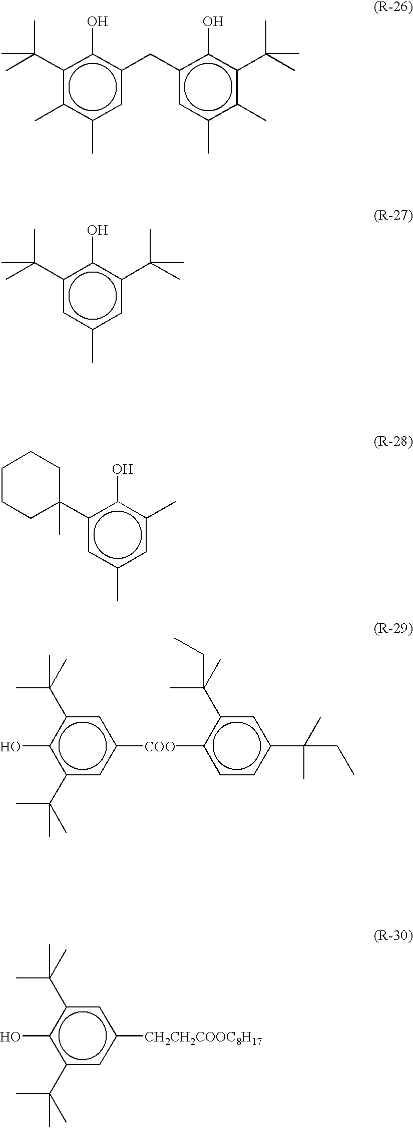

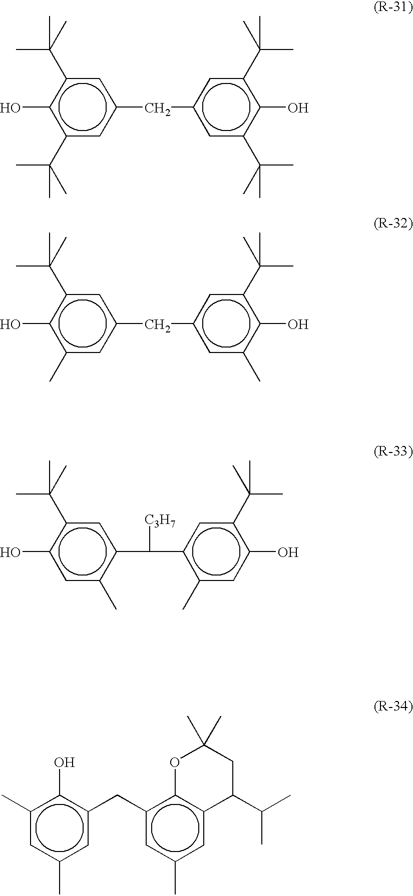

In the present invention, the reducing agent is preferably added in an amount of 0.1 to 2.0 mmol/m², more preferably 0.2 to 1.6 mmol/m², still more preferably 0.3 to 1.4 mmol/m². The surface side having thereon an image forming layer preferably contains the reducing agent in an amount of 5 to 50 mol %, more preferably 8 to 30 mol %, still more preferably 10 to 20 mol % per mol of silver. The reducing agent is preferably incorporated in an image forming layer.

The reducing agent may be incorporated in the coating solution in any form, for example, in the form of a solution, an emulsified dispersion or a solid fine grain dispersion and the resulting coating solution is then incorporated in the photothermographic material.

Examples of the well-known emulsification dispersion method include a method of dissolving the reducing agent using an oil such as dibutyl phthalate, tricresyl phosphate, glyceryl triacetate or diethyl phthalate, or an auxiliary solvent such as ethyl acetate or cyclohexanone, and mechanically forming an emulsified dispersion.

Examples of the solid fine grain dispersion method include a method of dispersing a powdery reducing agent in an appropriate solvent such as water using a ball mill, a colloid mill, a vibrating ball mill, a sand mill, a jet mill, a roller mill or an ultrasonic wave, thereby preparing a solid dispersion. At this time, a protective colloid (e.g., polyvinyl alcohol) or a surfactant (for example, an anionic surfactant such as sodium triisopropylnaphthalenesulfonate (a mixture of three substances different each other in the substitution position of an isopropyl group)) may be used. In the above-described mills, it is the common practice to use beads such as zirconia as a dispersion medium. In the dispersion, Zr eluted from these beads may be mixed and it is usually mixed in an amount of from 1 ppm to 1000 ppm, though depending on the dispersing conditions. The content of Zr in the photothermographic material not greater than 0.5 mg per g of silver is permissible.

It is preferred to add an antiseptic (e.g., benzoisothiazolinone sodium salt) to the aqueous dispersion.

(Development Accelerator)

In the photothermographic material of the present invention, preferably used as a development accelerator are sulfonamide phenol derivatives represented by formula (A) described in Japanese Patent Application No. 267222/2000 or 330234/2000, hindered phenol compounds represented by the formula (II) described in Japanese Patent Laid-Open No. 92075/2001, hydrazine compounds represented by the formula (I) described in Japanese Patent Laid-Open No. 62895/1998 or Japanese Patent Laid-Open No. 15116/1999, or represented by the formula (1) described in Japanese Patent Application No. 074278/2001, and phenol or naphthol compounds represented by the formula (2) described in Japanese Patent Application No. 76240/2000. These development accelerators are used in an amount of from 0.1 to 20 mol %, preferably from 0.5 to 10 mol %, more preferably 1 to 5 mol % relative to the reducing agent. Similar methods to those employed for the reducing agent can be applied to the introduction of the development accelerator to the photothermographic material, but addition as a solid dispersion or emulsified dispersion is especially preferred. When it is added as an emulsified dispersion, addition as an emulsified dispersion obtained using a high-boiling-point solvent which is a solid at room temperature and a low-boiling point auxiliary solvent or addition as a so-called oilless emulsified dispersion without using a high-boiling-point solvent is preferred.

(Hydrogen Bond Forming Compound)

In the case where the reducing agent for use in the present invention has an aromatic hydroxyl group (—OH), particularly, in the case where it is bisphenol as described above, a non-reducing compound having a group capable of forming a hydrogen bond with such a group is preferably used in combination. Examples of the group capable of forming a hydrogen bond with a hydroxyl group or amino group include a phosphoryl group, a sulfoxide group, a sulfonyl group, a carbonyl group, an amide group, an ester group, a urethane group, a ureido group, a tertiary amino group and a nitrogen-containing aromatic group. Of these, preferred are the compounds having a phosphoryl group, a sulfoxide group, an amide group (provided that it does not have a >N—H group but has been blocked like >N—Ra (wherein Ra is a substituent excluding H)), a urethane group (provided that it does not have a >N—H group but has been blocked like —N—Ra (wherein Ra is a substituent excluding H)) or a ureido group (provided that it does not have a >N—H group but has been blocked like —N—Ra (wherein Ra is a substituent excluding H)).

In the present invention, the particularly preferred hydrogen bond forming compound is a compound represented by the following formula (D):

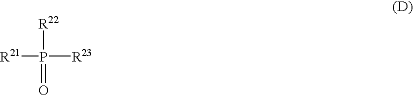

In formula (D), R²¹ to R²³ each independently represents an alkyl group, an aryl group, an alkoxy group, an aryloxy group, an amino group or a heterocyclic group, and each may be unsubstituted or substituted. When any one of R²¹ to R¹³ is substituted, examples of the substituent include halogen atoms, alkyl groups, aryl groups, alkoxy groups, amino groups, acyl groups, acylamino groups, alkylthio groups, arylthio groups, a sulfonamide group, acyloxy groups, an oxycarbonyl group, a carbamoyl group, a sulfamoyl group, a sulfonyl group and a phosphoryl group. The substituent is preferably an alkyl group or an aryl group and specific examples thereof include a methyl group, an ethyl group, an isopropyl group, a t-butyl group, a t-octyl group, a phenyl group, a 4-alkoxyphenyl group and a 4-acyloxyphenyl group.

Specific examples of the alkyl group represented by each of R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group and a 2-phenoxypropyl group. Examples of the aryl group include a phenyl group, a cresyl group, a xylyl group, a naphthyl group, a 4-t-butylphenyl group, a 4-t-octylphenyl group, a 4-anisidyl group and a 3,5-dichlorophenyl group. Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group.

Examples of the aryloxy group include a phenoxy group, a cresyloxy group, an isopropylphenoxy group, a 4-t-butylphenoxy group, a naphthoxy group and a biphenyloxy group. Examples of the amino group include a dimethylamino group, a diethylamino group, a dibutylamino group, a dioctylamino group, an N-methyl-N-hexylamino group, a dicyclohexylamino group, a diphenylamino group and an N-methyl-N-phenylamino group.

R²¹ to R²³ each preferably represents an alkyl group, an aryl group, an alkoxy group or an aryloxy group. In view of the effect of the present invention, at least one of R²¹ to R²³ is preferably an alkyl group or an aryl group and more preferably, two or more thereof are an alkyl group or an aryl group. In view of the availability at a low cost, all of the R²¹ to R²³ preferably represent the same group.

Specific examples of the hydrogen bond forming compound for use in the present invention including the compound of the formula (D) are set forth below, however, the present invention is not limited thereto.

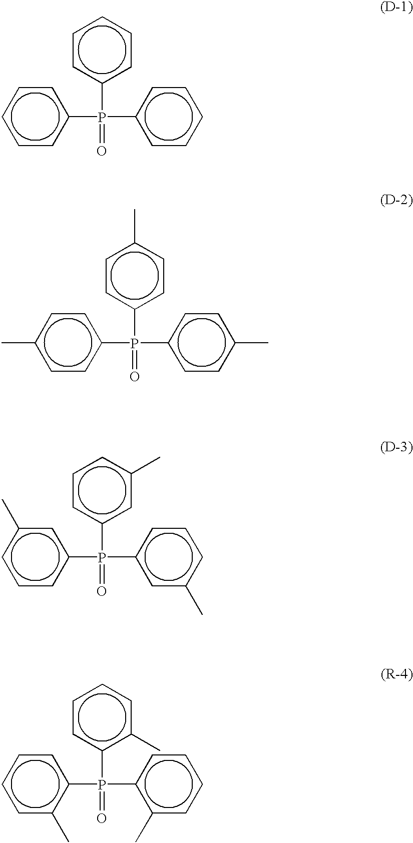

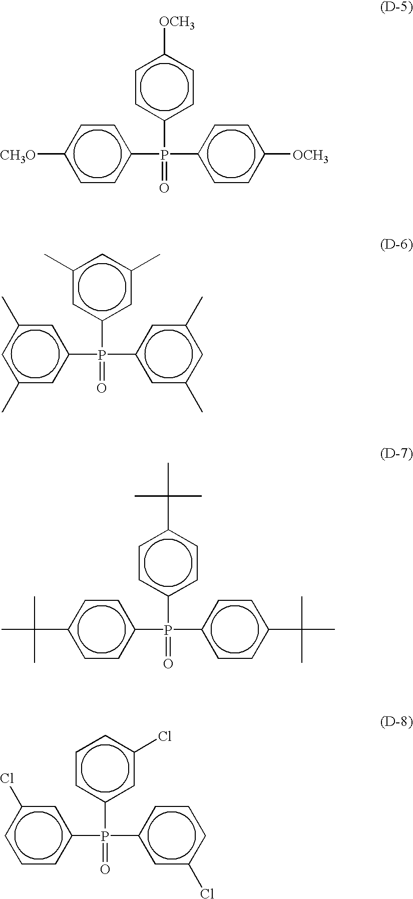

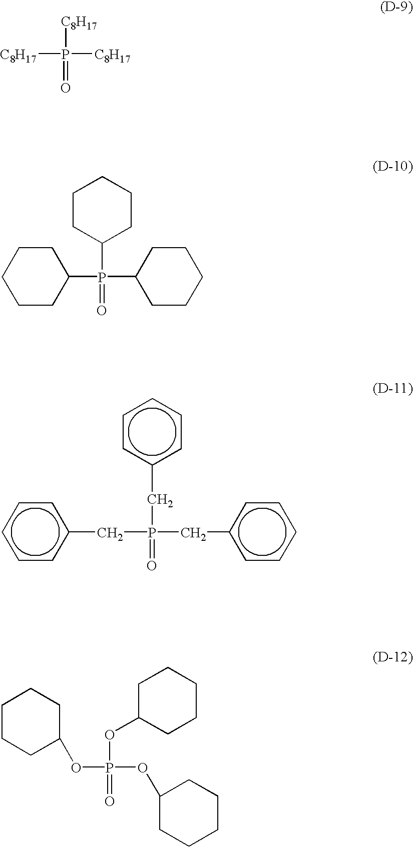

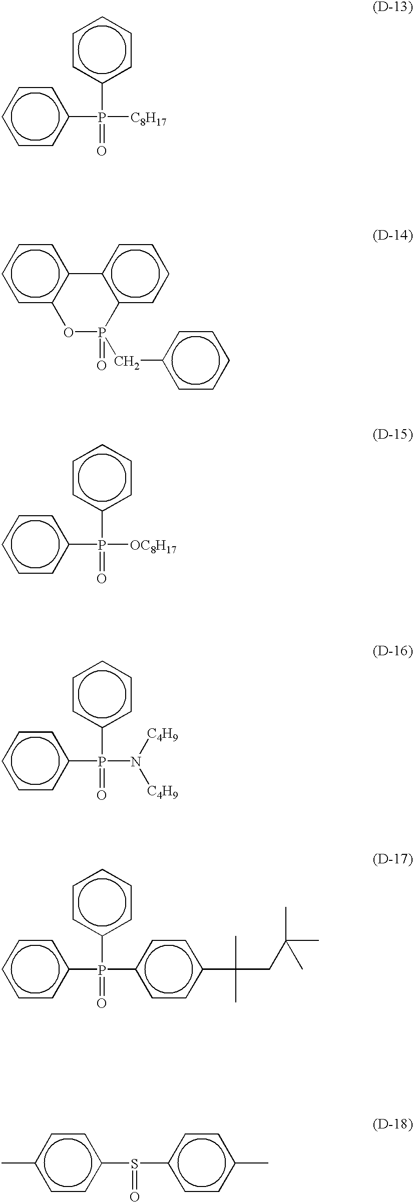

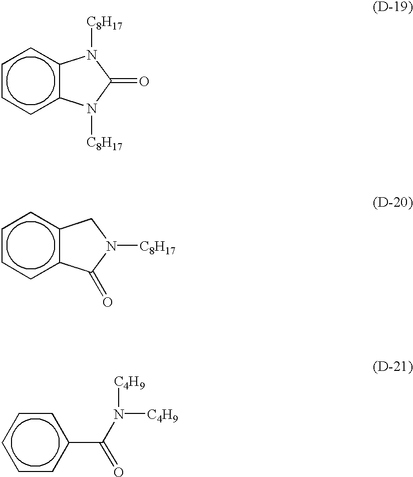

In addition to these compounds, specific examples of the hydrogen bond forming compound include those described in European Patent No. 1096310, Japanese Patent Application Nos. 270498/2000 and 124796/2001.

The compound represented by formula (D) for use in the present invention can be used in the photothermographic material after, similar to the reducing agent, incorporated into a coating solution in the form of a solution, an emulsified dispersion or a solid fine grain dispersion. In the solution state, this compound forms a hydrogen bond forming complex with a compound having a phenolic hydroxyl group or an amino group and depending on the combination of the reducing agent and the compound represented by formula (D), the complex can be isolated in the crystal state. Use of the thus-isolated crystal powder as a solid fine grain dispersion is particularly preferred for attaining stable performances. Alternatively, a method of mixing the reducing agent with the compound represented by formula (D) each in the powder form and dispersing the resulting mixture in a sand grinder mill by using an appropriate dispersant, thereby forming a complex is also preferably used.

The compound of the formula (D) for use in the present invention is preferably used in an amount of from 1 to 200 mol %, more preferably from 10 to 150 mol %, still more preferably from 20 to 100 mol %, based on the reducing agent.

(Hydrazine Compound)

In the formula (A), R³¹ represents a C₆₋₄₀ aryl group or a C₂₋₄₀ heterocyclic group.

Examples of the aryl group represented by R³¹ include phenyl and naphthyl groups which may have a substituent. Any substituent capable of substituting to the benzene ring can be used and examples include halogen atoms, alkyl groups, aryl groups, heterocyclic groups, a hydroxyl group, alkoxy groups, aryloxy groups, acyloxy groups, alkylthio groups, arylthio groups, amino groups, acylamino groups, a sulfonamido group, a ureido group, a urethane group, acyl groups, alkoxycarbonyl groups, a carbamoyl group, a sulfamoyl group, a sulfonyl group, sulfoxide group, cyano group, a nitro group, sulfo group and a carboxyl group.

Preferred substituents of the aryl group represented by R³¹ are electron-withdrawing groups and at least one of them is a halogen atom, a heterocyclic group, acyl groups, an alkoxycarbonyl group, a carbamoyl group, a sulfamoyl group, a sulfonyl group, a sulfoxide group, a cyano group, a nitro group, a fluoroalkyl group such as trifluoromethyl or a fluoroaryl group such as pentafluorophenyl, or an electron-withdrawing group at least equal thereto in electron withdrawing property. Of these, strong electron-withdrawing groups such as alkoxycarbonyl, carbamoyl, sulfamoyl, sulfonyl, cyano and trifluoromethyl groups are preferred, with alkoxycarbonyl, sulfonyl, cyano and trifluoromethyl groups being particularly preferred.

The number of the substituents possessed by the aryl group represented by R³¹ ranges from 0 to 5, at least one of which is preferably the above-described strong electron-withdrawing group. The aryl group having, as a substituent, at least one strong electron-withdrawing group substituted further with the above-described electron-withdrawing group is more preferred.

Preferred examples of the heterocyclic group represented by R³¹ include pyridine, pyrazine, pyrimidine, pyridazine, 1,2,4-triazine, 1,3,5-triazine, pyrrole, imidazole, pyrazole, 1,2,3-triazole, 1,2,4-triazole, tetrazole, 1,3,4-thiadiazole, 1,2,4-thiadiazole, 1,2,5-thiadiazole, 1,3,4-oxadiazole, 1,2,4-oxadiazole, 1,2,5-oxadiazole, thiazole, oxazole, isothiazole, isoxazole and thiophene rings. Condensed rings thereof are also preferred.

These heterocyclic groups may have a substituent. When they have at least two substituents, they may be the same or different. Examples of the substituent include halogen atoms, alkyl groups, aryl groups, a carbonamide group, alkylsulfonamide groups, arylsulfonamide groups, alkoxy groups, aryloxy groups, alkylthio groups, arylthio groups, a carbamoyl group, a sulfamoyl group, a cyano group, alkylsulfonyl groups, arylsulfonyl groups, alkoxycarbonyl groups, aryloxycarbonyl groups and acyl groups. When these substituents can be substituted, they may have a substituent further. Preferred examples of such a substituent include halogen atoms, alkyl groups, aryl groups, a carbonamide group, alkylsulfonamide groups, arylsulfonamide groups, alkoxy groups, aryloxy groups, alkylthio groups, arylthio groups, acyl groups, alkoxycarbonyl groups, aryloxycarbonyl groups, a carbamoyl group, a cyano group, a sulfamoyl group, alkylsulfonyl groups, arylsulfonyl groups and acyloxy groups.

Preferred examples of the heterocyclic group represented by R³² include C₁₋₄₀ alkyl groups, C₂₋₄₀ alkenyl groups, alkynyl groups, C₃₋₄₀ cycloalkyl groups, C₆₋₄₀ aryl groups and C₂₋₄₀ heterocyclic groups. They may have a substituent further.

When R³² represents an alkyl group, it is preferably a primary C₄₋₃₀ alkyl group, a secondary C₃₋₃₀ alkyl group or a tertiary C₄₋₃₀ alkyl group, more preferably, a primary C₆₋₁₈ alkyl group, a secondary C₃₋₁₈ alkyl group or a tertiary C₄₋₁₈ alkyl group. Of these, secondary and tertiary alkyl groups are preferred, of which tertiary alkyl groups are more preferred.

Specific examples of the alkyl group include methyl, propyl, n-butyl, n-hexyl, n-octyl, n-dodecyl, n-hexadecyl, neopentyl, 2-ethylhexyl, 2-octyloctyl, isopropyl, 1-hexylhexyl, t-butyl, 1,1,3,3-tetramethyloctyl, 1,1-dimethylhexyl, 1,1-dimethyldecyl, benzyl, phenethyl, phenoxyethyl and 2,-di-t-amylphenoxypropyl.

When R³² represents an alkenyl group, it is preferably a C₂₋₂₀ alkenyl group such as vinyl, allyl or oleyl.

When R³² represents a cycloalkyl group, it is preferably a C₃₋₂₀ cycloalkyl group such as cyclopropyl, 1-ethylcyclopropyl, cyclopentyl, cyclohexyl, 1-methylcyclohexyl, 2,2,2-bicyclooctyl, norbornyl or adamantyl.

Examples of the aryl group represented by R³² include phenyl and naphthyl which may have a substituent. Any substituent capable of substituting to the benzene ring is usable. Examples of the substituent include halogen atoms, alkyl groups, aryl groups, heterocyclic groups, a hydroxyl group, alkoxy groups, aryloxy groups, acyloxy groups, alkylthio groups, arylthio groups, amino groups, acylamino groups, a sulfonamide group, a ureido group, a urethane group, acyl groups, alkoxycarbonyl groups, a carbamoyl group, a sulfamoyl group, a sulfonyl group, a sulfoxide group, a cyano group, a nitro group, a sulfo group and a carboxyl group.

Preferred examples of the heterocyclic group represented by R³² include pyridine, pyrazine, pyrimidine, pyridazine, 1,2,4-triazine, 1,3,5-triazine, pyrrole, imidazole, pyrazole, 1,2,3-triazole, 1,2,4-triazole, tetrazole, 1,3,4-thiadiazole, 1,2,4-thiadiazole, 1,2,5-thiadiazole, 1,3,4-oxadiazole, 1,2,4-oxadiazoe, 1,2,5-oxadiazole, thiazole, oxazole, isothiazole, isoxazole and thiophene rings. Condensed rings thereof are also preferred.

These heterocyclic groups may have a substituent. When they have at least two substituents, they may be the same or different. Examples of the substituent include halogen atoms, alkyl groups, aryl groups, a carbonamide group, alkylsulfonamide groups, arylsulfonamide groups, alkoxy groups, aryloxy groups, alkylthio groups, arylthio groups, a carbamoyl group, a sulfamoyl group, a cyano group, alkylsulfonyl groups, arylsulfonyl groups, alkoxycarbonyl groups, aryloxycarbonyl groups and acyl groups. When these substituents can be substituted, they may have a substituent further. Preferred examples of such a substituent include halogen atoms, alkyl groups, aryl groups, a carbonamide group, alkylsulfonamide groups, arylsulfonamide groups, alkoxy groups, aryloxy groups, alkylthio groups, arylthio groups, acyl groups, alkoxycarbonyl groups, aryloxycarbonyl groups, a carbamoyl group, a cyano group, a sulfamoyl group, alkylsulfonyl groups, arylsulfonyl groups and acyloxy groups.

Among the compounds represented by the formula (A), those having as R³¹ a 5- or 6-membered unsaturated ring are preferred, of which those having, as R³¹, a benzene, pyrimidine, 1,2,3-triazole, 1,2,4-triazole, tetrazole, 1,3,4-thiadiazole, 1,2,4-thiadiazole, 1,3,4-oxadiazole, 1,2,4-oxadiazole, thiazole, oxazole, isothiazole or isoxazole ring, or such a ring condensed with the benzene ring or unsaturated heterocycle, particularly a quinazoline ring are preferred. R³¹ preferably has at least one electron withdrawing substituent. Preferred examples of such a substituent include fluoroalkyl groups (such as trifluoromethyl, pentafluoroethyl, 1,1-difluoroethyl, difluoromethyl, fluoromethyl, pentafluoropropyl and pentafluorophenyl), a cyano group, halogen atoms (fluorine, chlorine, bromine and iodine), acyl groups, alkoxycarbonyl groups, a carbamoyl group, alkylsulfonyl groups, and arylsulfonyl groups. Of these, a trifluoromethyl group is particularly preferred as the substituent.

The specific examples of the compound represented by the formula (A) will be described below. It should however be borne in mind that the compounds usable in the present invention are not limited to these specific examples.

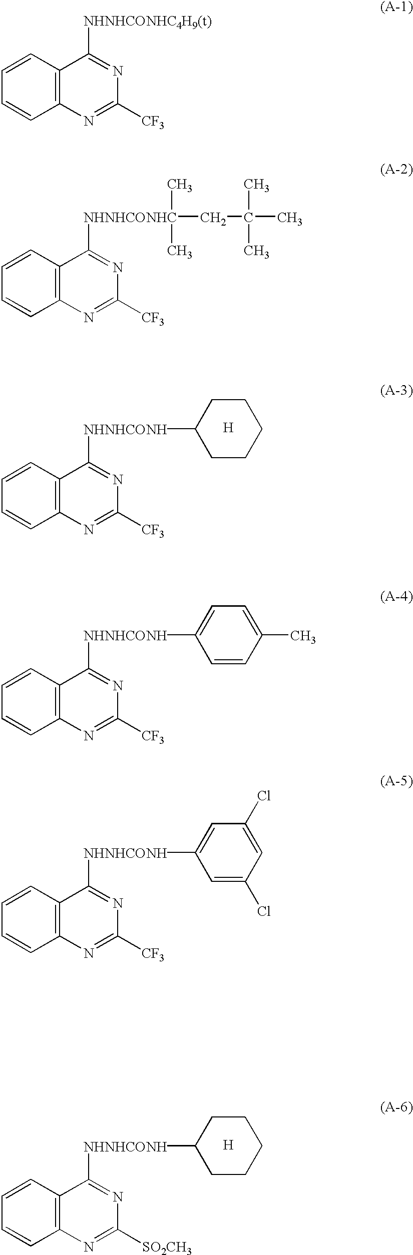

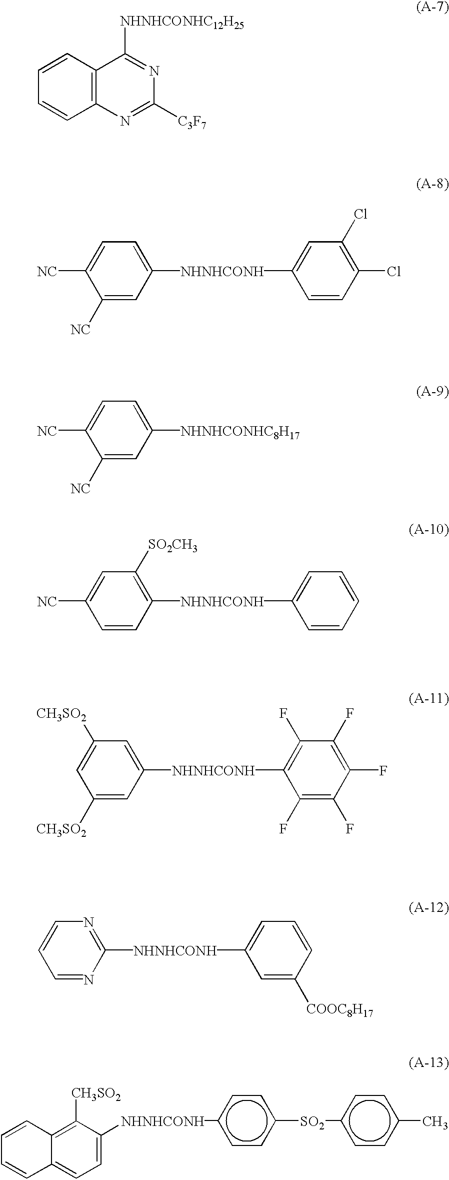

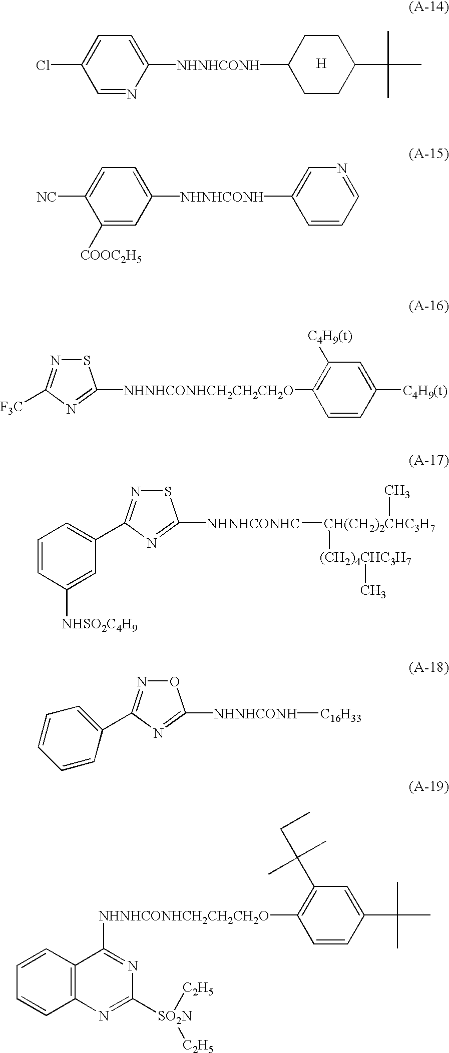

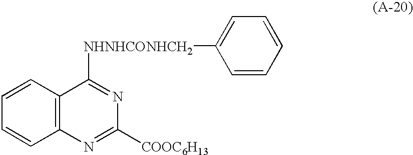

The compound of the formula (A) is preferably added in an amount of 0.1 to 100 mol %, more preferably 0.5 to 10 mol %, still more preferably 1 to 5 mol %, based on the amount of the reducing agent. The compound of the formula (A) is preferably incorporated in the image forming layer.

The compound of the formula (A) may be incorporated in the coating solution in any form, for example, in the form of a solution, an emulsified dispersion or a solid fine grain dispersion and the resulting coating solution is then incorporated in the photothermographic material.

Examples of the well-known emulsification dispersion method include a method of dissolving the compound of the formula (A) using an oil such as dibutyl phthalate, tricresyl phosphate, glyceryl triacetate or diethyl phthalate, or an auxiliary solvent such as ethyl acetate or cyclohexanone, and mechanically forming an emulsified dispersion.

Examples of the solid fine grain dispersion method include a method of dispersing the compound of the formula (A) in the powder form in an appropriate solvent such as water using a ball mill, a colloid mill, a vibrating ball mill, a sand mill, a jet mill, a roller mill or an ultrasonic wave, thereby preparing a solid dispersion. At this time, a protective colloid (e.g., polyvinyl alcohol) or a surfactant (for example, an anionic surfactant such as sodium triisopropylnaphthalenesulfonate (a mixture of three substances different each other in the substitution position of an isopropyl group)) may be used. In a water dispersion, an antiseptic (such as benzoisothiazolinone sodium salt) may be incorporated.

It is desired to incorporate the compound of the formula (A) in the coating solution by the solid dispersion method from the viewpoints of storage property of the photothermographic material and coating stability.

(Organic Silver Salt)

The organic silver salt usable in the present invention is relatively stable to light but forms a silver image when heated at 80° C. or greater in the presence of a photocatalyst (e.g., an exposed latent image of photosensitive silver halide) and a reducing agent. The organic silver salt may be any organic substance which will be a supply source of silver ions to be reduced to silver. Such a non-photosensitive organic silver salt is described in Japanese Patent Laid-Open No. 62899/1998 (paragraphs 0048 to 0049), European Patent Laid-Open No. 0803764A1 (lines 24, page 18 to line 37, page 19), European Patent Laid-Open No. 0962812A1, Japanese Patent Laid-Open No. 349591/1999, Japanese Patent Laid-Open No. 7683/2000, and Japanese Patent Laid-Open No. 72711/2000. The organic silver salt is preferably a silver salt of an organic acid, particularly a silver salt of a long chain aliphatic carboxylic acid (having from 10 to 30 carbon atoms, preferably from 15 to 28 carbon atoms). Preferred examples of the silver salt of a fatty acid include silver behenate, silver arachidate, silver stearate, silver oleate, silver laurate, silver caproate, silver myristate and silver palmitate, and mixtures thereof. In the present invention, of these silver salts of a fatty acid, those having a silver behenate content of 50 mol % or greater, more preferably 80 mol % or greater, still more preferably 90 mol % or greater are preferably employed.

The form of the organic silver salt usable in the present invention is not particularly limited and any one in the needle, bar, tabular and scaly form may be used.

In the present invention, organic silver salts in the scaly form are preferred. Those in the form of a short needle having a ratio of a long axis to a short axis not greater than 5, rectangular parallelopiped, cube or potato-like amphoteric grain are preferably employed. These organic silver salt grain features less fogging upon heat development than a long-needle grain having 5 or greater as a ratio of a long axis to a short axis. In this specification, a scaly organic silver salt is defined as follows. Supposing that the shape of an organic acid silver salt grain is caused to approximate to a rectangular parallelopiped and the sides thereof are designated as a, b, c (c may be equal to b) in the order of increasing length as a result of observation through an electron microscope, x is determined based on the calculation using shorter values of a and b.

x=b/a

In such a manner, x of about 200 grains is determined. When grains satisfy the following equation of an average value x (average)≧1.5, it is defined as a scaly grain. The equation is preferably 30≧x (average)≧1.5, more preferably 20≧x (mean)≧2.0. For your reference, the needle grain falls within the following range: 1≦x (average)<1.5.

In the scaly grain, the value (a) can be regarded as the thickness of a tabular grain having a principal plane having (b) and (c) as its sides. The average of (a) is preferably from 0.01 μm to 0.23 μm, more preferably from 0.1 μm to 0.20 μm. The average of c/b is preferably from 1 to 6, more preferably from 1.05 to 4, still more preferably from 1.1 to 3, especially from 1.1 to 2.

The grain size distribution of the organic silver salt is preferably monodisperse. The term “monodisperse” as used herein means that the percentage of the value obtained by dividing the standard deviation of the length of the short axis or long axis by the length of the short axis or long axis, respectively, is preferably 100% or less, more preferably 80% or less, further preferably 50% or less. The form of the organic silver salt can be determined from a transmission electron microscope image of organic silver salt dispersion. Another method for determining the monodispesibility is a method of determining the standard deviation of a volume weight average diameter of the organic silver salt. The percentage (coefficient of variation) of the value obtained by dividing the standard deviation by the volume weight average diameter is preferably 100% or less, more preferably 80% or less, still more preferably 50% or less. Monodispersibility can be determined from the grain size (volume weight average diameter) obtained, for example, by exposing an organic silver salt dispersed in a solution to a laser ray and determining an autocorrelation function of the fluctuation of the scattered light on the basis of a time change.

Known processes can be applied to the preparation of the organic silver salt usable in the present invention and dispersion thereof. Examples of the processes used as reference include those described in the above-described Japanese Patent Laid-Open No. 62899/1998, European Patent Laid-Open No. 0803763A1, European Patent Laid-Open No. 0962812A1, Japanese Patent Laid-Open Nos. 349591/1999, 7683/2000, and 72711/2000, Japanese Patent Application Laid-Open Nos. 348228 to 348230/1999, 203413/1999, 90093/2000, 195621/2000, 191226/2000, 213813/2000, 214155/2000 and 191226/2000.

If a photosensitive silver salt is caused to exist together with the organic silver salt upon its dispersion, fog increases and sensitivity seriously decreases. Therefore, it is preferred that the organic silver salt is substantially free of a photosensitive silver salt upon dispersion. In the present invention, the amount of the photosensitive silver salt to be dispersed in a water dispersion is preferably 1 mol % or less, more preferably 0.1 mol % per mol of the silver salt of an organic acid in the solution. It is still more preferred that the photosensitive silver salt is not added positively.

In the present invention, a photothermographic material can be produced by mixing a water dispersion of the organic silver salt and a water dispersion of the photosensitive silver salt. The mixing ratio of the organic silver salt to the photosensitive silver salt can be selected according to the purpose, however, a ratio of the photosensitive silver salt to the organic silver salt is preferably from 1 to 30 mol %, more preferably from 2 to 20 mol %, especially from 3 to 15 mol %. A method of using two or more organic silver salt water dispersions and two or more photosensitive silver salt water dispersions upon mixing is preferably employed for controlling the photographic properties.

The organic silver salt for use in the present invention may be used in any desired amount, however, the amount in terms of silver is preferably from 0.05 to 1.0 g/m², more preferably from 0.1 to 0.8 g/m², still more preferably from 0.2 to 0.7 g/m².

(Silver Halide)

No particular limitation is imposed on the halogen composition of the photosensitive silver halide to be used in the present invention. Silver chloride, silver bromochloride, silver bromide, silver bromoiodide, silver chlorobromoiodide and silver iodide are usable. Among them, silver bromide and silver bromoiodide are preferred. The distribution of the halogen composition in a grain may be uniform, or may change stepwise or continuously. A silver halide grain having a core/shell structure is preferably used. The core/shell grain preferably has a double to quintuple, more preferably a double to quadruplex structure. Further, a technique for localizing silver bromide or silver iodide on the surface of silver chloride, silver bromide or silver bromochloride grain is preferably used.

The method of forming a photosensitive silver halide is well known in the art and, for example, the methods described in Research Disclosure, No. 17029 (June, 1978) and U.S. Pat. No. 3,700,458 may be used. Specifically, a method of adding a silver-supplying compound and a halogen-supplying compound to gelatin or other polymer solution to prepare a photosensitive silver halide and mixing the silver halide with an organic silver salt is used. In addition, the methods described in Japanese Patent Laid-Open No. 119374/1999 (paragraph Nos. 0217 to 0224) and Japanese Patent Application Nos. 98708/1999 and Japanese Patent Application Laid-Open No. 347335/2000 are also preferably used.

The grain size of the photosensitive silver halide is preferably small for the purpose of minimizing turbidity after image formation. More specifically, the grain size is preferably not greater than 0.20 μm, more preferably from 0.01 to 0.15 μm, still more preferably from 0.02 to 0.12 μm. The term “grain size” as used herein means the diameter of a circle having the same area as the projected area (projected area of main plane, if the grain is tabular) of silver halide grain.

Examples of the shape of silver halide grain include cubic form, octahedral form, tabular form, spherical form, bar form and potato-like form and among these, cubic grain is particularly preferred in the present invention. A silver halide grain having a rounded corner is also preferably used. The face index (Miller indices) of the outer surface of the photosensitive silver halide grain is not particularly limited, however, {100} faces permitting a high spectral sensitization efficiency upon adsorption of a spectral sensitizing dye preferably occupy a high percentage. The percentage is preferably 50% or more, more preferably 65% or more, still more preferably 80% or more. The percentage of {100} faces, in the grain surface, according to the Miller indices can be determined by the method described in T. Tani, J. Imaging Sci., 29, 165 (1985) utilizing the adsorption dependency of {111} face and {100} face when a sensitizing dye is adsorbed.

In the present invention, a silver halide grain having, on the outermost surface thereof, a hexacyano metal complex allowed to exist is preferred. Examples of the hexacyano metal complex include [Fe(CN₆)]⁴⁻, [Fe(CN₆)]³⁻, [Ru(CN₆)]⁴⁻, [Os(CN₆)]⁴⁻, [Co(CN₆)]³⁻, [Rh(CN₆)]³⁻, [Ir(CN₆)]³⁻, [Cr(CN₆)]³⁻ and [Re(CN₆)]³⁻. In the present invention, hexacyano Fe complexes are preferred.

The hexacyano metal complex is present in the form of ion in an aqueous solution and therefore, the counter cation is not important, however, use of cations easily miscible with water and suitable for the precipitation operation of a silver halide emulsion, for example, alkali metal ions such as sodium ion, potassium ion, rubidium ion, cesium ion and lithium ion, ammonium ions, and alkylammonium ions (e.g., tetramethylammonium ion, tetraethylammonium ion, tetrapropylammonium ion, tetra(n-butyl)ammonium ion) is preferred.

The hexacyano metal complex may be added after mixing it with water, a mixed solvent of water and an appropriate organic solvent miscible with water (for example, an alcohol, ether, glycol, ketone, ester or amide), or gelatin.

The amount of the hexacyano metal complex is preferably from 1×10⁻⁵ to 1×10⁻² mol, more preferably from 1×10⁻⁴ to 1×10⁻³ mol, per mol of silver.

For allowing the hexacyano metal complex to exist on the outermost surface of a silver halide grain, the hexacyano metal complex is directly added after completion of the addition of an aqueous silver nitrate solution used for the grain formation but before initiation of the chemical sensitization step of performing chalcogen sensitization such as sulfur sensitization, selenium sensitization or tellurium sensitization or noble metal sensitization such as gold sensitization, for example, before the completion of charging step, during the water washing step, during the dispersion step, or before the chemical sensitization step. In order to stop growth of silver halide fine grains, the hexacyano metal complex is preferably added without delay after the grain formation but before the completion of charging step.

The addition of the hexacyano metal complex may be started after 96% by mass of the total amount of silver nitrate to be added for the grain formation is added, but is preferably started after 98% by mass, more preferably 99% by mass, of the total amount is added.

The hexacyano metal complex added after an aqueous silver nitrate solution is added immediately before the completion of grain formation can adsorb to the outermost surface of a silver halide grain and most of the complex thus adsorbed forms a sparingly-soluble salt with silver ion on the grain surface. This silver salt of hexacyano ferrate (II) is a salt more sparingly soluble than AgI and therefore, the redissolution of fine grains can be prevented, whereby silver halide fine grains having a small grain size can be produced.

The photosensitive silver halide grain for use in the present invention may contain a metal of Group VIII to Group X in the Periodic Table (showing Group I to Group XVIII) or a metal complex thereof. The metal of Group VIII to Group X of the Periodic Table or center metal of its metal complex is preferably rhodium, ruthenium or iridium. One metal complex may be used or two or more complexes of the same metal or different metals may also be used in combination. The metal complex content is preferably from 1×10⁻⁹ to 1×10⁻³ mol per mol of silver. These metals and metal complexes and the addition methods therefor are described in Japanese Patent Laid-Open No. 225449/1995, Japanese Patent Laid-Open No. 65021/1999 (paragraph Nos. 0018 to 0024) and Japanese Patent Laid-Open No. 119374/1999 (paragraph Nos. 0227 to 0240).

Furthermore, metal atoms (for example, [Fe(CN)₆]⁴⁻) which can be incorporated in the silver halide grain for use in the present invention, and the methods for desalting and chemical sensitization of a silver halide emulsion are described in Japanese Patent Laid-Open No. 84574/1999 (paragraph Nos. 0046 to 0050), Japanese Patent Laid-Open No. 65021/1999 (paragraph Nos. 0025 to 0031) and Japanese Patent Laid-Open No. 119374/1999 (paragraph Nos. 0242 to 0250).

As the gelatin contained in the photosensitive silver halide emulsion for use in the present invention, various gelatins can be used. In order to maintain good dispersion state of the photosensitive silver halide emulsion in the organic-silver-salt-containing coating solution, a low molecular weight gelatin having a molecular weight of 500 to 60,000 is preferably used. This low molecular weight gelatin may be used either upon grain formation or upon dispersion after desalting, but latter is preferred.

As the sensitizing dye to be used in the invention, a sensitizing dye which can spectrally sensitize silver halide grains in the desired wavelength range and has a spectral sensitivity adapted for the spectral properties of the exposing light source when the sensitizing dye is adsorbed on the silver halide grains can be selected advantageously. The details of these sensitizing dyes and methods for the addition thereof are described in Japanese Patent Laid-Open No. 65021/1999 (paragraphs [0103]-[0109]), compound represented by the formula (II) in Japanese Patent Laid-Open No. 186572/1998, dyes represented by the formula (I) in Japanese Patent Laid-Open No. 119374/1999 and paragraph [0106] thereof, U.S. Pat. No. 5,510,236, dyes described in Example 5 of U.S. Pat. No. 3,871,887, Japanese Patent-Laid-Open No. 96131/1990, dyes disclosed in Japanese Patent Laid-Open No. 48753/1984, EP-A-0803764A1 (page 19, line 38 to Page 20, line 35), and Japanese Patent Application Nos. 2000-86865, 2000-102560 and 2000-205399. These sensitizing dyes may be used either singly or in combination. In the invention, the time at which the sensitizing dye is added to the silver halide emulsion is preferably between after desalting step and coating, more preferably between after desalting and beginning of chemical ripening.

Although the sensitizing dye can be added in a desired amount in the present invention in accordance with the performance such as sensitivity or fogging, it is preferably from 10⁻⁶ mol to 1 mol, more preferably from 10⁻⁴ mol to 10⁻¹ mol per mol of silver halide in the photosensitive layer.

In the present invention, a supersensitizer may be used for improving the spectral sensitization efficiency. Examples of the supersensitizer usable in the present invention include the compounds described in European Patent No. 587,338, U.S. Pat. Nos. 3,877,943 and 4,873,184, and Japanese Patent Laid-Open Nos. 341432/1993, 109547/1999 and 111543/1998.

It is preferred that in the present invention, the photosensitive silver halide grain has been chemically sensitized by sulfur sensitization, selenium sensitization or tellurium sensitization. As the compounds preferably used in the sulfur sensitization, selenium sensitization or tellurium sensitization, known compounds, for example, compounds described in Japanese Patent Laid-Open No. 128768/1995 can be used. Particularly in the present invention, tellurium sensitization is preferred and the compounds described in Japanese Patent Laid-Open No. 65021/1999 (paragraph No. 0030) and the compounds represented by formulas (II), (III) and (IV) of Japanese Patent Laid-Open No. 313284/1993 are more preferred.

In the present invention, the chemical sensitization may be performed at any stage after grain formation but before coating. Examples of the timing of performing the chemical sensitization include, after desalting, (1) before spectral sensitization, (2) simultaneously with spectral sensitization, (3) after spectral sensitization and (4) immediately before coating. Particularly, the chemical sensitization is preferably performed after spectral sensitization.

The amount of a sulfur, selenium or tellurium sensitizer for use in the present invention varies depending on the silver halide grain to be used, chemical ripening conditions and the like, but these sensitizers each is preferably used in an amount of 10⁻⁸ to 10⁻² mol, preferably about 10⁻⁷ to 10⁻³ mol, per mol of silver halide. In the present invention, the conditions for the chemical sensitization are not particularly limited but the pH is from 5 to 8, the pAg is from 6 to 11 and the temperature is from about 40 to 95°C.

In the silver halide emulsion for use in the present invention, a thiosulfonic acid compound may be added by the method described in European Patent Laid-Open No. 293917.

In the photothermographic material for use in the present invention, photosensitive silver halide emulsions may be used either singly or in combination (for example, emulsions different in the average grain size, in the halogen composition, in the crystal habit or in the chemical sensitization conditions). By using a plurality of photosensitive silver halides different in sensitivity, gradation can be controlled. Examples of the technique related to them include Japanese Patent Laid-Open Nos. 119341/1982, 106125/1978, 3929/1972, 55730/1973, 5187/1971, 73627/1975 and 150841/1982. Any two of plural photosensitive silver halide emulsions used in combination are preferably different in sensitivity by at least 0.2 logE.

The amount of the photosensitive silver halide is preferably, in terms of the coated silver amount per m² of the photothermographic material, from 0.03 to 0.6 g/m², more preferably from 0.07 to 0.4 g/m², most preferably from 0.05 to 0.3 g/m². The amount of the photosensitive silver halide is preferably from 0.01 to 0.5 mol, more preferably from 0.02 to 0.3 mol, still more preferably from 0.03 mol to 0.2 mol, per mol of the organic silver salt.

As the method and conditions for mixing the photosensitive silver halide and the organic silver salt which have been prepared individually, no particular limitation is imposed insofar as the advantage of the present invention can be exhibited sufficiently. Usable is a method of mixing the silver halide grains and the organic silver salt each after the completion of preparation, in a ball mill, a sand mill, a colloid mill, a vibration mill, a homogenizer or the like, or a method of preparing the organic silver salt by adding thereto, at arbitrary timing during the preparation of the organic silver salt, the photosensitive silver halide of which preparation has been completed. Upon mixing, it is preferred to mix two or more organic silver salt water dispersions with two or more photosensitive silver salt water dispersions in order to control the photographic properties.

In the present invention, the timing of adding the silver halide to a coating solution of an image forming layer is from 180 minutes before the coating to immediately before the coating, preferably from 60 minutes to 10 seconds before the coating. The mixing method and the mixing conditions are not particularly limited insofar as the advantage of the present invention can be brought about satisfactorily. Specifically, a method of mixing in a tank designed to give a desired average residence time which is calculated from the addition flow rate and the liquid transfer amount to the coater, or a method using a static mixer as described in N. Harnby, F. Edwards and A. W. Nienow (translated by Koji Takahashi), Ekitai Kongo Gijutsu (Liquid Mixing Technique), Chap. 8, published by Nikkan Kogyo Shinbun Sha (1989) may be used.

(Binder)

As the binder for the organic-silver-salt-containing layer in the present invention, any polymer may be used and the suitable binder is transparent or translucent and generally colorless. Examples thereof include natural resins, polymers and copolymers; synthetic resins, polymers and copolymers; and film-forming media such as gelatins, rubbers, poly(vinyl alcohols), hydroxyethyl celluloses, cellulose acetates, cellulose acetate butyrates, poly(vinyl pyrrolidones), casein, starch, poly(acrylic acids), poly(methyl methacrylates), poly(vinyl chlorides), poly(methacrylic acids), styrene-maleic anhydride copolymers, styrene-acrylonitrile copolymers, styrene-butadiene copolymers, poly(vinyl acetals) (e.g., poly(vinyl formal), poly(vinyl butyral)), poly(esters), poly(urethanes), phenoxy resin, poly(vinylidene chlorides), poly(epoxides), poly(carbonates), poly(vinyl acetates), poly(olefins), cellulose esters and poly(amides). The binder may also be coated and formed from water, an organic solvent or an emulsion.

In the present invention, the binder usable in combination with the organic-silver-salt-containing layer preferably has a glass transition temperature of from 10 to 80° C. (such binder may hereinafter be called a “high Tg binder”), more preferably from 15 to 70° C., still more preferably from 20 to 65° C.

In the present specification, the Tg is calculated by the following equation:

1/Tg=Σ(Xi/Tgi)

wherein assuming that the polymer is the copolymer of n monomer components from i=1 to i=n, Xi is the weight fraction (ΣXi=1) of the i-th monomer and Tgi is the glass transition temperature (absolute temperature) of a homopolymer of the i-th monomer, provided that Σ is the sum of i=1 to i=n. Incidentally, for the glass transition temperature (Tgi) of a homopolymer of each monomer, the values described in J. Brandrup and E. H. Immergut, Polymer Handbook, 3rd ed., Wiley-Interscience (1989) are employed.

As the binder, at least two polymers may be used in combination. A polymer having a glass transition temperature of 20° C. or more and another polymer having a glass transition temperature less than 20° C. may be used in combination. When two or more polymers different in Tg are blended, the weight average Tg thereof preferably falls within the above-described range.

In the present invention, it is preferred to form the film of an organic-silver-salt-containing layer by coating and drying a coating solution containing water as 30% by mass or more of a solvent.

In the present invention, the performance is enhanced when the organic-silver-salt-containing layer is formed by coating and drying a coating solution with 30% by mass or more of the solvent being water, furthermore when the binder of the organic-silver-salt-containing layer is soluble or dispersible in an aqueous solvent (water solvent), particularly when the binder is composed of a polymer latex having an equilibrium moisture content at 25° C. and 60% RH of 2% by mass or less. In a most preferred form, the binder is prepared to have an ion conductivity of 2.5 mS/cm or less. For preparing such a binder, usable is a method of synthesizing a polymer and then purifying it using a membrane having a separating function.

The term “an aqueous solvent” in which the above-described polymer is soluble or dispersible means water or a mixture of water and 70% by mass or less of a water-miscible organic solvent. Examples of the water-miscible organic solvent include alcohols such as methyl alcohol, ethyl alcohol and propyl alcohol, cellosolves such as methyl cellosolve, ethyl cellosolve and butyl cellosolve, ethyl acetate, and dimethylformamide.

The term “aqueous solvent” is used for a system where the polymer is not thermodynamically dissolved but is present in the so-called dispersed state.

The term “equilibrium moisture content at 25° C. and 60% RH” can be expressed as follows by using the weight W₁ of a polymer in the humidity equilibration in an atmosphere of 25° C. and 60% RH and the weight W₀ of a polymer in the bone dry state at 25° C.:

Equilibrium moisture content at 25° C. and 60% RH=

{(W₁−W₀)/W₀}×100(% by mass)

With respect to the definition and the measuring method of moisture content, for example, Kobunshi Kogaku Koza 14, Kobunshi Zairyo Shiken Hou (Polymer Material Testing Method), compiled by Kobunshi Gakkai, published by Chijin Shokan, may be referred to.

In the present invention, the equilibrium moisture content at 25° C. and 60% RH of the binder polymer is preferably 2% by mass or less, more preferably from 0.01 to 1.5% by mass, still more preferably from 0.02 to 1% by mass.

In the present invention, a polymer dispersible in an aqueous solvent is particularly preferred. Examples of the dispersed state include a case where fine grains of a water-insoluble hydrophobic polymer are dispersed in the form of latex, and a case where polymer molecules are dispersed in the molecular state or by forming micelles. Either case is preferred. The former one is more preferred. The average particle size of the dispersed particles is from 1 to 50,000 nm, preferably from 5 to 1000 nm, more preferably from 10 to 500 nm, still more preferably from 50 to 200 nm. The particle size distribution of the dispersed particles is not particularly limited and the dispersed particles may have either a wide particle size distribution or a monodisperse particle size distribution. Use of a mixture of at least two dispersed particles having a monodisperse particle size distribution is preferred for controlling the physical properties of the coating solution.

In the present invention, in a preferred embodiment of the polymer dispersible in an aqueous solvent, hydrophobic polymers such as acrylic polymers, poly(esters), rubbers (e.g., SBR resin), poly(urethanes), poly(vinyl chlorides), poly(vinyl acetates), poly(vinylidene chlorides) and poly(olefin)s, may be preferably used. These polymers may be linear, branched or crosslinked, may be a homopolymer obtained by polymerizing a single monomer, or may be a copolymer obtained by polymerizing two or more monomers. In the case of a copolymer, the copolymer may be a random copolymer or a block copolymer. The molecular weight of this polymer is, in terms of the number average molecular weight, from 5,000 to 1,000,000, preferably from 10,000 to 200,000. If the molecular weight is too small, the resulting emulsion layer is insufficient in the mechanical strength, whereas if the molecular weight is excessively large, the film forming property is poor. The molecular weight outside the above-described range is therefore not preferred. Crosslinkable polymer latices are particularly preferred.

(Specific Examples of a Latex)

Specific examples of preferred polymer latices include the below-described ones. The polymer latex is expressed using the starting material monomers. The unit of the numerical value in the parentheses is % by mass and the molecular weight is a number average molecular weight. A polyfunctional monomer forms a crosslink structure so that the concept of molecular weight cannot be applied. Such a case is indicated by the term “crosslinkable” and the molecular weight is omitted. “Tg” means a glass transition temperature.

P-1: latex of -MMA(70)-EA(27)-MAA(3)- (molecular weight: 37,000, Tg 61° C.)

P-2: latex of -MMA(70)-2EHA(20)-St(5)-AA(5)- (molecular weight: 40,000, Tg 59° C.)

P-3: latex of -St(50)-Bu(47)-MAA(3)- (crosslinkable, Tg −17° C.)

P-4: latex of -St(68)-Bu(29)-AA(3)- (crosslinkable, Tg 17° C.)

P-5: latex of -St(71)-Bu(26)-AA(3)- (crosslinkable, Tg: 24° C.)

P-6: latex of -St(70)-Bu(27)-IA(3)- (crosslinkable)

P-7: latex of -St(75)-Bu(24)-AA(1)- (crosslinkable, Tg 29° C.)

P-8: latex of -St(60)-Bu(35)-DVB(3)-MAA(2)- (crosslinkable)

P-9: latex of -St(70)-Bu(25)-DVB(2)-AA(3)- (crosslinkable)

P-10: latex of -VC(50)-MMA(20)-EA(20)-AN(5)-AA(5)- (molecular weight: 80,000)

P-11: latex of -VDC(85)-MMA(5)-EA(5)-MAA(5)- (molecular weight: 67,000)

P-12: latex of -Et(90)-MAA(10)- (molecular weight: 12,000)

P-13: latex of -St(70)-2EHA(27)-AA(3) (molecular weight: 130,000, Tg 43° C.)

P-14: latex of -MMA(63)-EA(35)-AA(2) (molecular weight: 33,000, Tg 47° C.)

P-15: latex of -St(70.5)-Bu(26.5)-AA(3)- (crosslinkable, Tg: 23° C.)

P-16: latex of -St(69.5)-Bu(27.5)-AA(3)- (crosslinkable, Tg: 20.5° C.)

The abbreviations of the above-described structures indicate the following monomers: MMA: methyl methacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, and IA: itaconic acid.

These polymer latexes are commercially available and the following polymers may be used. Examples of the acrylic polymer include “Sebian A-4635, 4718 and 4601” (each, trade name; product of Daicel Chemical Industries, Ltd.) and “Nipol Lx811, 814, 821, 820 and 857” (each, trade name; product of Nippon Zeon K. K.); those of poly(esters) include “FINETEX ES650, 611, 675 and 850” (each, trade name; product of Dai-Nippon Ink & Chemicals, Inc.), and “WD-size” and “WMS” (each, trade name; product of Eastman Chemical Products, Inc.); those of poly(urethanes) include “HYDRAN AP10, 20, 30 and 40” (each, trade name; product of Dai-Nippon Ink & Chemicals, Inc.); those of rubbers include “LACSTAR 7310K, 3307B, 4700H and 7132C” (each, trade name; product of Dai-Nippon Ink & Chemicals, Inc.), “Nipol Lx416, 410, 438C and 2507” (each, trade name; product of Nippon Zeon K. K.); those of poly(vinyl chlorides) include “G351 and G576” (each, trade name; product of Nippon Zeon K. K.); those of poly(vinylidene chlorides) include “L502 and L513” (each, trade name; product of Asahi Chemical Industry Co., Ltd.); and those of poly(olefins) include “Chemipearl S120 and SA100” (each, trade name; product of Mitsui Petrochemical Industries, Ltd.).

These polymer latices may be used singly or, if desired, two or more thereof may be blended.

(Preferred Latex)

The polymer latex for use in the present invention is particularly preferably a latex of styrene-butadiene copolymer. In the styrene-butadiene copolymer, a weight ratio of the styrene monomer unit to the butadiene monomer unit is preferably from 40:60 to 95:5. Furthermore, the styrene monomer unit and the butadiene monomer unit preferably account for 60 to 99% by mass of the copolymer. The polymer latex for use in the invention preferably contains acrylic acid or methacrylic acid in an amount of 1 to 6% by mass, more preferably 2 to 5% by mass, relative to the sum of styrene and butadiene. The polymer latex for use in the invention preferably contains acrylic acid.

Examples of the styrene-butadione copolymer latex which is preferably used in the present invention include the above-described latices P-3 to P-8, P-14 and P-15 and commercially available products “LACSTAR-3307B”, “7132C” and “Nipol Lx416”.

The organic-silver-salt-containing layer of the photothermographic material of the present invention may contain, if desired, a hydrophilic polymer such as gelatin, polyvinyl alcohol, methyl cellulose, hydroxypropyl cellulose or carboxymethyl cellulose. The amount of the hydrophilic polymer is preferably 30% by mass or less, more preferably 20% by mass or less, based on the entire binder.

In the present invention, the organic-silver-salt-containing layer (namely, image forming layer) is preferably formed using a polymer latex and the amount of the binder in the organic-silver-salt-containing layer is preferably, in terms of a weight ratio of the entire binder/organic silver salt, from 1/10 to 10/1, more preferably from 1/3 to 5/1, still more preferably from 1/1 to 3/1.

Such an organic-silver-salt-containing layer usually serves also as a photosensitive layer (emulsion layer) containing a photosensitive silver halide which is a photosensitive silver salt. In this case, a weight ratio of the entire binder/silver halide is from 400 to 5, preferably from 200 to 10.

In the present invention, the total binder amount of the image forming layer is preferably from 0.2 to 30 g/m², more preferably from 1 to 15 g/m², still more preferably from 2 to 10 g/m². The image forming layer for use in the present invention may contain a crosslinking agent for forming a crosslink structure or a surfactant for improving the coatability.

(Preferable Solvent for a Coating Solution)

In the present invention, the solvent (for the sake of simplicity, the solvent and the dispersion medium are collectively called a solvent here) used in the coating solution for the organic-silver-salt-containing layer of the photothermographic material is preferably an aqueous solvent containing at least 30% by mass of water. As a component other than water, an optional water-miscible organic solvent may be used, such as methyl alcohol, ethyl alcohol, isopropyl alcohol, methyl cellosolve, ethyl cellosolve, dimethylformamide and ethyl acetate. The solvent of the coating solution preferably has a water content of 50% by mass or more, more preferably 70% by mass or more. Preferred examples of solvent compositions include, in addition to water, a 90:10 mixture of water and methyl alcohol, a 70:30 mixture of water and methyl alcohol, a 80:15:5 mixture of water, methyl alcohol and dimethylformamide, a 85:10:5 mixture of water, methyl alcohol and ethyl cellosolve and 85:10:5 mixture of water, methyl alcohol and isopropyl alcohol (the unit of each numeral is % by mass).

(Antifoggant)

Examples of the antifoggant, stabilizer and stabilizer precursor usable in the present invention include those described in Japanese Patent Laid-Open No. 62899/1998 (paragraph No. 0070) and European Patent Laid-Open No. 0803764A1 (page 20, line 57 to page 21, line 7), and compounds described in Japanese Patent Laid-Open Nos. 281637/1997 and 329864/1997, U.S. Pat. Nos. 6,083,681 and 6,083,681, and European Patent 1048975. The antifoggant preferably used in the present invention is an organic halide and examples thereof include those disclosed in the patents described in Japanese Patent Laid-Open No. 65021/1999 (paragraph Nos. 0111 to 0112). In particular, preferred are organic halogen compounds represented by formula (P) of Japanese Patent Laid-Open No. 284399/2000, organic polyhalogen compounds represented by formula (II) of Japanese Patent Laid-Open No. 339934/1998, and organic polyhalogen compounds described in Japanese Patent Laid-Open Nos. 31644/2001 and 33911/2001.

(Other Antifoggants)

Other examples of the antifoggant include mercury(II) salts described in Japanese Patent Laid-Open No. 65021/1999 (paragraph No. 0113), benzoic acids described in the same patent publication (paragraph No. 0114), salicylic acid derivatives described in Japanese Patent Laid-Open No. 206642/2000, formalin scavenger compounds represented by formula (S) of Japanese Patent Laid-Open No. 221634/2000, triazine compounds according to claim 9 of Japanese Patent Laid-Open No. 352624/1999, compounds represented by the formula (III) of Japanese Patent Laid-Open No. 11791/1994, and 4-hydroxy-6-methyl-1,3,3a,7-tetrazaindene.

For the purpose of preventing fogging, the photothermographic material of the present invention may contain an azolium salt. Examples of the azolium salt include the compounds represented by formula (XI) of Japanese Patent Laid-Open No. 193447/1984, the compounds described in Japanese Patent Publication No. 12581/1980, and the compounds represented by formula (II) of Japanese Patent Laid-Open No. 153039/1985. The azolium salt may be added to any site of the photothermographic material but is preferably added to a layer on the surface having a photosensitive layer, more preferably to the organic-silver-salt-containing layer. The azolium salt may be added in any step during the preparation of the coating solution. In the case of adding the azolium salt to the organic-silver-salt-containing layer, the addition may be made in any step between the preparation of the organic silver salt and the preparation of the coating solution, however, the addition is preferably made between after the preparation of the organic silver salt and immediately before the coating. The azolium salt may be added in any form such as powder, solution or fine grain dispersion. It may be added as a mixed solution with other additives such as sensitizing dye, reducing agent and toning agent. In the present invention, the azolium salt may be added in any amount but the amount is preferably from 1×10⁻⁶ to 2 mol, more preferably from 1×10⁻³ to 0.5 mol, per mol of silver.

In the present invention, a mercapto compound, a disulfide compound or a thione compound may be incorporated so as to control development by suppression or promotion, enhance the spectral sensitization efficiency or improve the shelf life before or after the development. Examples of these compounds include the compounds described in Japanese Patent Laid-Open No. 62899/1998 (paragraph Nos. 0067 to 0069), the compounds represented by formula (I) of Japanese Patent Laid-Open No. 186572/1998 (and specific examples thereof described in paragraph Nos. 0033 to 0052) and the compounds described in European Patent Laid-Open No. 0803764A1 (page 20, lines 36 to 56). Of these, mercapto-substituted heteroaromatic compounds described in Japanese Patent Laid-Open Nos. 297367/1998, 304875/1998 and 100358/2001 are preferred.

As the mercapto compound, mercaptotetrazole, mercaptotriazole and mercaptoimidazole are preferred. Their hetero ring may be condensed further with an aromatic ring. Of these, 1-phenyl-5-mercaptotetrazoles are preferred, with 1-phenyl-5-mercaptotetrazole substituted, at the 1-phenyl group thereof, with an acylamino, ureido, urethane, sulfo or carboxyl group being particularly preferred. The preferred position of the substituent is the 3-position of the phenyl group.

Most preferred mercapto compounds are 1-(3-methylureidopheny)-5-mercaptotetrazole and 1-(3-sulfophenyl)-5-mercaptotetrazole and alkali metal salts thereof.

(Toning Agent)

A toning agent is preferably added to the photothermographic material of the present invention. Examples include those described in Japanese Patent Laid-Open No. 62899/1998 (paragraph Nos. 0054 to 0055), European Patent Laid-Open NO. 0803764A1 (page 21, lines 23 to 48), Japanese Patent Laid-Open No. 356317/2000 and Japanese Patent Application No. 187298/2000. Particularly preferred are phthalazinones (phthalazinone, phthalazinone derivatives, and metal salts of phthalazinone, e.g., 4-(1-naphthyl)phthalazinone, 6-chlorophthalazinone, 5,7-dimethoxyphthalazinone, 2,3-dihydro-1,4-phthalazinedione); combinations of a phthalazinone and a phthalic acid (e.g., phthalic acid, 4-methylphthalic acid, 4-nitrophthalic acid, diammonium phthalate, sodium phthalate, and potassium phthalate, tetrachlorophthalic anhydride); phthalazines (phthalazine, phthalazine derivatives, and metal salts of phthalazine, e.g., 4-(1-naphthyl)phthalazine, 6-isopropylphthalazine, 6-t-butylphthalazine, 6-chlorophthalazine, 5,7-dimethoxyphthalazine, and 2,3-dihydrophthalazine); and combinations of a phthalazine and a phthalic acid, with the combinations of a phthalazine and a phthalic acid being more preferred. Of these, a combination of 6-isopropylphthalazine and phthalic acid or 4-methylphthalic acid is especially preferred.

(Other Additives)

The plasticizer and lubricant which can be used in the photosensitive layer in the present invention are described in Japanese Patent Laid-Open No. 65021/1999 (paragraph No. 0117); the ultrahigh contrast-providing agent for the formation of an ultrahigh contrast image and addition method or addition amount of the agent, each usable in the present invention, are described in Japanese Patent Laid-Open No. 65021/1999 supra (paragraph No. 0118), Japanese Patent Laid-Open No. 223898/1999 (paragraph Nos. 0136 to 0193), Japanese Patent Laid-Open No. 2884399/2000 (compounds represented by formula (H), formulas (1) to (3) and formulas (A) and (B)), and Japanese Patent Application No. 91652/1999 (compounds represented by formulas (III) to (V), specific compounds: Chem. 21 to Chem. 24); and the contrast-promoting agent usable in the present invention is described in Japanese Patent Laid-Open No. 65021/1999 (paragraph No. 0102) and Japanese Patent Laid-Open No. 11-223898 (paragraph Nos. 0194 to 0195).

When a formic acid or a formate is used as a strong foggant, it is preferably incorporated in the side having an image forming layer containing a photosensitive silver halide in an amount of 5 mmol or less, more preferably 1 mmol or less, per mol of silver.

In the case where the ultrahigh contrast-providing agent is used in the photothermographic material of the present invention, an acid resulting from the hydration of diphosphorus pentoxide, or a salt thereof is preferably used in combination. Examples of the acid resulting from the hydration of diphosphorus pentoxide, and salts thereof include metaphosphoric acid (and salts thereof), pyrophosphoric acid (and salts thereof), orthophosphoric acid (and salts thereof), triphosphoric acid (and salts thereof), tetraphosphoric acid (and salts thereof), and hexametaphosphoric acid (and salts thereof). Among these, particularly preferred are orthophosphoric acid (and salts thereof) and hexametaphosphoric acid (and salts thereof). Specific examples of these salts include sodium orthophosphate, sodium dihydrogen orthophosphate, sodium hexametaphosphate and ammonium hexametaphosphate.

The amount (coated amount per m² of the photothermographic material) of the acid resulting from the hydration of disphosphorus pentoxide, or a salt thereof may be a desired amount determined in accordance with the properties such as sensitivity and fog, but is preferably from 0.1 to 500 mg/m², more preferably 0.5 to 100 mg/m².

(Layer Constitution)

The photothermographic material of the present invention may have a surface protective layer formed thereon in order to prevent the adhesion of the image forming layer. The surface protective layer may be a single layer or composed of plural layers. A description on the surface protective layer can be found in Japanese Patent Laid-Open No. 11-65021 (paragraph Nos. 0119 to 0120) and Japanese Patent Application No. 2000-171936.

In the present invention, the binder for the surface protective layer is preferably gelatin but polyvinyl alcohol (PVA) may also be preferably used or may be preferably used in combination with gelatin. Examples of the gelatin usable here include inert gelatin (e.g., “Nitta gelatin 750”, trade name) and phthalated gelatin (e.g., “Nitta gelatin 801”, trade name). Examples of PVA include those described in Japanese Patent Laid-Open No. 171936/2000 (paragraph Nos. 0009 to 0020) and preferred examples thereof include completely saponified product “PVA-105”, partially saponified product “PVA-205” and “PVA-335” and modified polyvinyl alcohol “MP-203” (each, trade name, product of Kuraray Co., Ltd). The coated amount (per m² of the support) of polyvinyl alcohol of the protective layer (per one layer) is preferably from 0.3 to 4.0 g/m², more preferably from 0.3 to 2.0 g/m².

Particularly when the photothermographic material of the present invention is used for printing where the dimensional change becomes a problem, a polymer latex is preferably used for the surface protective layer or the back layer. A description on such a polymer latex can be found in Taira Okuda and Hiroshi Inagaki (compilers), Gosei Jushi Emulsion (Synthetic Resin Emulsion), published by Kobunshi Kankokai (1978), Takaaki Sugimura, Yasuo Kataoka, Soichi Suzuki and Keishi Kasahara (compilers), Gosei Latex no Oyo (Application of Synthetic Latex), Kobunshi Kankokai (1993), and Soichi Muroi, Gosei Latex no Kagaku (Chemistry of Synthetic Latex), published by Kobunshi Kankokai (1970). Specific examples of the polymer latex include a latex of methyl methacrylate (33.5% by mass)/ethyl acrylate (50% by mass)/methacrylic acid (16.5% by mass) copolymer, a latex of methyl methacrylate (47.5% by mass)/butadiene (47.5% by mass)/itaconic acid (5% by mass) copolymer, a latex of ethyl acrylate/methacrylic acid copolymer, a latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer and a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer. For the binder of the surface protective layer, a combination of polymer latices described in Japanese Patent Application No. 6872/1999, and the techniques described in Japanese Patent Application Nos. 143058/1999 (paragraph Nos. 0021 to 0025), 6872/1999 (paragraph Nos. 0027 to 0028) and 199626/1998 (paragraph Nos. 0023 to 0041) may also be applied. The percentage of the polymer latex in the surface protective layer is preferably from 10 to 90% by mass, more preferably from 20 to 80% by mass, based on the entire binder.

The coating quantity (per m² of the support) of the entire binder (including water-soluble polymer and latex polymer) for the surface protective layer (per one layer) is preferably from 0.3 to 5.0 g/m², more preferably from 0.3 to 2.0 g/m².

In the present invention, the temperature upon preparation of a coating solution for the image forming layer is preferably from 30 to 65° C., more preferably from 35 but less than 60° C., still more preferably from 35 to 55° C. Furthermore, the coating solution for the image forming layer immediately after the addition of the polymer latex is preferably kept at a temperature of 30 to 65° C.

In the present invention, the image forming layer is composed of one or more layer(s) on the support. In the case where the image forming layer is composed of a single layer, the layer comprises an organic silver salt, a photosensitive silver halide, a reducing agent and a binder and if desired, additionally contains desired materials such as a color toning agent, a coating aid and other adjuvant. In the case where the image forming layer is composed of two or more layers, a first image forming layer (usually a layer adjacent to the support) contains an organic silver salt and a photosensitive silver halide, and a second image forming layer or these two layers contain some other components. In the structure of a multi-color photosensitive heat-developable photographic material, a combination of these two layers may be provided for each color or as described in U.S. Pat. No. 4,708,928, all the components may be contained in a single layer. In the case of a multi-dye multicolor photosensitive heat-developable photographic material, respective emulsion layers are held separated each other by using therebetween a functional or nonfunctional barrier layer, as described in U.S. Pat. No. 4,460,681,.

In the present invention, the photosensitive layer may contain various dyes or pigments (for example, C.I. Pigment Blue 60, C.I. Pigment Blue 64, C.I. Pigment Blue 15:6) from the standpoint of improving the tone, inhibiting the generation of interference fringes on laser exposure or preventing the irradiation. These are described in detail in WO98/36322, Japanese Patent Laid-Open No. 268465/1998 and Japanese Patent Laid-Open No. 338098/1999.

In the photothermographic material of the present invention, an antihalation layer can be provided in the side farther from a light source with respect to the photosensitive layer.

The photothermographic material generally has a non-photosensitive layer in addition to the photosensitive layer. The non-photosensitive layer can be classified by its position, into (1) a protective layer provided on a photosensitive layer (in the side farther from the support), (2) an interlayer provided between a plurality of photosensitive layers or between a photosensitive layer and a protective layer, (3) an undercoat layer provided between a photosensitive layer and a support, and (4) a back layer provided on the side opposite the photosensitive layer. In the photothermographic material, a filter layer is provided as the layer (1) or (2) and an antihalation layer is provided as the (3) or (4).

The present invention features the use of a reflective support so that it is preferred to provide an antihalation layer as the layer (3).

A description on the antihalation layer can be found in Japanese Patent Laid-Open No. 65021/1999 (paragraph Nos. 0123 to 0124), and Japanese Patent Laid-Open Nos. 223898/1999, 230531/1997, 36695/1998, 104779/1998, 231457/1999, 352625/1999 and 352626/1999.

The antihalation layer contains an antihalation dye having absorption in the exposure wavelength. When the exposure wavelength exists in the infrared region, an infrared absorption dye may be used. In such a case, a dye having no absorption in the visible region is preferred.

When the halation is prevented using a dye having absorption in the visible dye, it is preferred to allow substantially no color of the dye to remain after the formation of an image. For this purpose, means capable of decolorizing under the action of heat at the heat development is preferably used. In particular, the non-photosensitive layer is preferably rendered to function as an antihalation layer by adding thereto a thermally decolorizable dye and a base precursor. Japanese Patent Laid-Open No. 231457/1999 describes these techniques. In the case of exposure in a red light region, use of a non-decolorizable dye or pigment whose absorption shows a sharp hemline on the shortwave side of an absorption waveform within a range of from 650 nm to 750 nm and whose absorption at 620 nm is suppressed to 0.2 or less and absorption at not greater than 600 nm is suppressed to 1 or less is also preferred. As an example of such a dye, cyanine dyes in the associated form or microcrystal form can be given. Squarylium dyes also have a preferably absorption waveform.

The amount of the decolorizable dye is determined according to the using purpose of the dye. In general the decolorizable dye is used in an amount of giving an optical density (absorbance) in excess of 0.1 when measured at the objective wavelength. The optical density is preferably from 0.15 to 2, more preferably 0.2 to 1. For attaining such an optical density, the amount of the dye is generally from about 0.001 to 1 g/m².

By such decolorization of a dye, the optical density after heat development can be reduced to 0.1 or less. Two or more decolorizable dyes may be used in combination in the thermally decolorizable recording material or photothermographic material. Also, two or more base precursors may be used in combination.

In the thermal decolorization using these decolorizable dye and base precursor, a substance (e.g., diphenylsulfone, 4-chlorophenyl(phenyl)sulfone) capable of lowering the melting point by 3° C. or more when mixed with the base precursor, as described in Japanese Patent Laid-Open No. 352626/1999, or 2-naphthylbenzoate is preferably used in combination in view of the thermal decolorizability and the like.

In the present invention, a coloring agent having an absorption maximum at 300 to 450 nm can be added for the purpose of improving silver tone or a time-dependent change of image. Examples of such a coloring agent include those described in Japanese Patent Laid-Open Nos. 210458/1987, 104046/1988, 103235/1988, 208846/1988, 306436/1988, 314535/1988, 61745/1989 and 100363/2001.

Such a coloring agent is usually added in an amount ranging from 0.1 mg/m² to 1 g/m² and the layer to which the coloring agent is added is preferably a back layer provided on the side opposite to the photosensitive layer.

The photothermographic material of the present invention is preferably a so-called one-side photothermographic material having at least a photosensitive layer containing a silver halide emulsion on one side of the support and a back layer on the other side.

(Matting Agent)

In the present invention, a matting agent is preferably added for improving the carrying property. Examples of the matting agent include those described in Japanese Patent Laid-Open No. 65021/1999 (paragraph Nos. 0126 to 0127). The amount of the matting agent is, in terms of the coating quantity per m² of the photothermographic material, preferably from 1 to 400 mg/m², more preferably from 5 to 300 mg/m².

The matting agent may be either finite or amorphous, but is preferably finite and spherical. Its average particle size preferably ranges from 0.5 to 10 μm, more preferably from 1.0 to 8.0 μm, still more preferably from 2.0 to 6.0 μm. The coefficient of variation of size distribution is preferably 50% or less, more preferably 40% or less, still more preferably 30% or less. The term “coefficient of variation” as used herein means a value expressed by (standard deviation of particle size)/(average of particle size)×100. Use of at least two matting agents exhibiting a small coefficient of variation and different each other by at least 3 as an average particle size ratio is preferred.

The matting degree on the emulsion surface may be any value insofar as a stardust failure does not occur, but is preferably, in terms of the Beck smoothness, from 30 to 2,000 seconds, more preferably from 40 to 1,500 seconds. The Beck smoothness can be easily determined according to Japanese Industrial Standard (JIS) P8119, “Test Method for Smoothness of Paper and Paperboard by Beck Tester” and TAPPI Standard Method T479.

As for the matting degree of the back layer for use in the present invention, the Beck smoothness is preferably from 10 to 1,200 seconds, more preferably from 20 to 800 seconds, still more preferably from 40 to 500 seconds.

In the present invention, the matting agent is preferably incorporated in the outermost surface layer, a layer acting as the outermost surface layer, or a layer close to the outer surface layer, or preferably incorporated in a layer acting as a protective layer.

The back layer which can be applied to the present invention is described in Japanese Patent Laid-Open No. 65021/1999 (paragraph Nos. 0128 to 0130).

In the present invention, the pH on the layer surface of the heat-developable photosensitive layer before heat development is preferably 7.0 or less, more preferably 6.6 or less. The lower limit thereof is not particularly limited but is about 3. The most preferred pH range is from 4 to 6.2. Use of a nonvolatile acid such as organic acid (e.g., phthalic acid derivative) or sulfuric acid or a volatile base such as ammonia for adjusting the pH on the layer surface is preferred from the standpoint of reducing the pH on the layer surface. In particular, since ammonia is readily volatilized and can be removed before the coating step or the heat development, it is preferred for achieving a low layer surface pH.

Furthermore, a combined use of ammonia with a nonvolatile base such as sodium hydroxide, potassium hydroxide or lithium hydroxide is preferred. The method of measuring the pH on the layer surface is described in Japanese Patent Application No. 87297/1999 (paragraph No. 0123).

In the present invention, a hardening agent may be used for each of the layers such as photosensitive layer, protective layer and back layer. As the hardening agent, in addition to those described in T. H. James, The Theory of the Photographic Processes Fourth Edition, pp. 77-87, Macmillan Publishing Co., Inc. (1977), chrome alum, 2,4-dichloro-6-hydroxy-s-triazine sodium salt, N,N-ethylene-bis(vinylsulfonacetamide) and N,N-propylenebis(vinylsulfonacetamide), polyvalent metal ion described in ibid., page 78, polyisocyanates described in U.S. Pat. No. 4,281,060 and Japanese Patent Laid-Open No. 208193/1994, epoxy compounds described in U.S. Pat. No. 4,791,042, and vinyl sulfone-base compounds described in Japanese Patent Laid-Open No. 89048/1987 are preferably used.

The hardening agent is added as a solution. This solution is added to the coating solution for the protective layer from 180 minutes to immediately before the coating, preferably from 60 minutes to 10 seconds before the coating. No particular limitation is imposed on the mixing method and conditions insofar as the effect of the present invention is satisfactorily brought out. Specific examples of the mixing method include a method of mixing the solutions in a tank designed to give a desired average residence time which is calculated from the addition flow rate and the liquid transfer amount to the coater, and a method using a static mixer as described in N. Harnby, M. F. Edwards and A. W. Nienow (translated by Koji Takahashi), Ekitai Kongo Gijutsu (Liquid Mixing Technique), Chap. 8, published by Nikkan Kogyo Shinbun Sha (1989).

The surfactant which can be applied to the present invention is described in Japanese Patent Laid-Open No. 65021/1999 (paragraph No. 0132), the solvent is described in paragraph No. 0133 of the same, the support is described in paragraph No. 0134 of the same, the antistatic or conducting layer is described in paragraph No. 0135 of the same, the method for obtaining a color image is described in paragraph No. 0136 of the same, and the lubricant is described in Japanese Patent Laid-Open No. 84573/1999 (paragraph Nos. 0061 to 0064) and Japanese Patent Application No. 106881/1999 (paragraph Nos. 0049 to 0062).

In the present invention, the photothermographic material preferably has a conductive layer containing a metal oxide. As the conductive material for the conductive layer, metal oxides having increased conductivity by introducing therein oxygen defects or different metal atoms are preferred. Preferred examples of the metal oxide include ZnO, TiO₂ and SnO₂. Addition of Al or In to ZnO₂, addition of Sb, Nb, P or halogen element to SnO₂ and Nb or Ta to TiO₂ is preferred. In particular, SnO₂ added with Sb is preferred. The amount of the different metal atom to be introduced in the metal oxide is preferably from 0.01 to 30 mol %, more preferably from 0.1 to 10 mol %. Although the metal oxide may be in any one of spherical, needle-like and plate-like forms, needle-like particles having a long axis/short axis ratio of 2.0 or greater, preferably 3.0 to 50 are preferred for imparting conductivity to the conductive material. The metal oxide is preferably used in an amount of from 1 to 1000 mg/m², more preferably from 10 to 500 mg/m², still more preferably from 20 to 200 mg/m². Although the conductive layer of the present invention may be disposed either on the emulsion surface side or back surface side, disposal between the support and back layer is preferred. The specific examples of the conductive layer of the present invention are described in Japanese Patent Laid-Open No. 295146/1995 or 223901/1999.

In the present invention, use of a fluorine surfactant is preferred. Specific examples of the fluorine surfactant include compounds described in Japanese Patent Laid-Open Nos. 197985/1998, 19680/2000, and 214554/2000. High-molecular fluorine surfactants as described in Japanese Patent Laid-Open No. 281636/1997 are also preferred. In the present invention, use of fluorine surfactants as described in Japanese Patent Application No. 206560/2000 is especially preferred.

The support of the present invention is preferably polyester, particularly polyethylene terephthalate, subjected to a heat treatment in a temperature range of 130 to 185° C. so as to relax the remaining internal distortion in the film during the biaxial stretching, thereby eliminating occurrence of thermal shrinkage distortion during the heat development. In the case of a photothermographic material for medical uses, the support may be colored with a bluish dye (for example, Dye-1 described in Example of Japanese Patent Laid-Open No. 240877/1996) or may be colorless. For the support, a technique for undercoating a water-soluble polyester as described in Japanese Patent Laid-Open No. 84574/1999, a styrene-butadiene copolymer as described in Japanese Patent Laid-Open No. 186565/1998, or a vinylidene chloride copolymer as described in Japanese Patent Laid-Open No. 39684/2000 and Japanese Patent Application No. 106881/1999 (paragraph Nos. 0063 to 0080) is preferably applied. As for the antistatic layer or undercoat, the techniques as described in Japanese Patent Laid-Open Nos. 143430/1981, 143431/1981, 62646/1983, 120519/1981, and 84573/1999 (paragraph Nos. 0040 to 0051), U.S. Pat. No. 5,575,957 and Japanese Patent Laid-Open No. 223898/1999 (paragraph Nos. 0078 to 0084) can be applied.

The photothermographic material is preferably a mono-sheet type (a type where an image can be formed on the photothermographic material without using another sheet such as image-receiving material).

The photothermographic material may further contain an antioxidant, a stabilizer, a plasticizer, an ultraviolet absorber and a coating aid. These various additives are added to either a photosensitive layer or a non-photosensitive layer. These additives are usable with reference to WO98/36322, European Patent No. 803764A1, Japanese Patent Laid-Open No. 186567/1998 and Japanese Patent Laid-Open No. 18568/1998.

The photothermographic material of the present invention may be coated in any manner. Various coating operations including extrusion coating, slide coating, curtain coating, dip coating, knife coating, flow coating, and extrusion coating using a hopper of a kind as described in U.S. Pat. No. 2,681,294 may be used. The extrusion coating or slide coating as described in Stephen F. Kistler and Petert M. Schweizer, LIQUID FILM COATING, pp. 399-536, CHAPMAN & HALL (1977) is preferred, with the slide coating, being more preferred. An example of the shape of the slide coater used in the slide coating is shown in FIG. 11b.1 of ibid., page 427. If desired, two or more layers may be simultaneously coated using a method described in ibid., pp. 399-536, U.S. Pat. No. 2,761,791 and British Patent No. 837,095.

The coating solution for the organic-silver-salt-containing layer used in the present invention is preferably a so-called thixotropic fluid. This technique is usable with reference to Japanese Patent Laid-Open No. 52509/1999. The coating solution for the organic-silver-salt-containing layer used in the present invention preferably has a viscosity at a shear rate of 0.1S⁻¹, of 400 to 100,000 mPa·s, more preferably from 500 to 20,000 mPa·s. At a shear rate of 1,000 S⁻¹, the viscosity is preferably from 1 to 200 mPa·s, more preferably from 5 to 80 mPa·s.

Examples of the technique which can be used in the photothermographic material of the present invention include those described in European Patent Nos. 803764A1 and 883022A1, WO98/36322, Japanese Patent Laid-Open Nos. 62648/1981, 62644/1983, 43766/1997, 281637/1997, 297367/1997, 304869/1997, 311405/1997, 329865/1997, 10669/1998, 62899/1998, 69023/1998, 186568/1998, 90823/1998, 171063/1998, 186565/1998, 186567/1998, 186569/1998 to 186572/1998, 197974/1998, 197982/1998, 197983/1998, 197985/1998 to 197987/1998, 207001/1998, 207004/1998, 221807/1998, 282601/1998, 288823/1998, 288824/1998, 307365/1998, 312038/1998, 339934/1998, 7100/1999, 15105/1999, 24200/1999, 24201/1999, 30832/1999, 84574/1999, 65021/1999, 109547/1999, 125880/1999, 129629/1999, 133536/1999 to 133539/1999, 133542/1999, 133543/1999, 223898/1999, 352627/1999, 305377/1999, 305378/1999, 305384/1999, 305380/1999, 316435/1999, 327076/1999, 338096/1999, 338098/1999, 338099/1999 and 343420/1999, and Japanese Patent Application Nos. 187298/2000, 10229/2000, 47345/2000, 206642/2000, 98530/2000, 98531/2000, 112059/2000, 112060/2000, 112104/2000, 112064/2000 and 171936/2000.

(Packaging Material)

The photothermographic material of the present invention is preferably wrapped with a packaging material having a low oxygen permeability and/or water permeability in order to suppress variations in photographic performance upon storage or straighten the curl or curing habit. The oxygen permeability at 25° C. is preferably 50 ml/atm·m²·day (57·10⁻¹⁶ mPa·s) or less, more preferably 10 ml/atm·m²·day (11.4·10⁻¹⁶ mPa·s) or less, still more preferably 1.0 ml/atm·m²·day (1.14·10⁻¹⁶ mPa·s) or less. The water permeability is preferably 10 g/atm·m²·day (11.4·10⁻¹⁰ g/Pa.m²·s) or less, more preferably 5 g/atm·m²·day (5.7·10⁻¹⁰ g/Pa.m²·s) or less, still more preferably 1 g/atm·m²·day (1.14·10⁻¹⁰ g/Pa.m²·s) or less. Specific examples of the packaging material low in a low oxygen permeability and/or water permeability include those described in Japanese Patent Laid-Open Nos. 254793/1996 and 206653/2000.

(Heat development)

The photothermographic material of the present invention may be developed by any method but usually, the development is performed by raising the temperature of an imagewise exposed photothermographic material. The development temperature is preferably from 80 to 250° C., more preferably from 100 to 140° C., still more preferably from 110 to 130° C. The development time is preferably from 1 to 60 seconds, more preferably from 3 to 30 seconds, still more preferably from 5 to 25 seconds, especially from 7 to 15 seconds.

As a heat development system, either a drum heater or a plate heater may be used, but the latter is preferred. As heat development system using the plate heater, the method described in Japanese Patent-Laid-Open No. 1335721/1999 is preferred. Employed in it is a heat developing apparatus for obtaining a visible image by bringing a photothermographic material having formed thereon a latent image into contact with heating means in the heat-developing section. It is characterized by that the heating means has a plate heater, a plurality of press rollers are disposed to face each other along one surface of the plate heater, and the photothermographic material is caused to pass between the press rollers and the plate heater, thereby performing the heat development. The plate heater is preferably divided into 2 to 6 stages and the temperature at the leading end is preferably lowered by approximately from 1 to 10° C. For example, four plate heaters capable of controlling temperature individually are used and they are controlled to be 112° C., 120° C., 121° C. and 121° C., respectively. Such a method is described also in Japanese Patent Laid-Open No. 30032/1979, where the water content or organic solvent contained in the photothermographic material can be excluded out of the system and the photothermographic material can be prevented from a change in the shape of the support which is otherwise caused by abrupt heating of the photothermographic material.

Although any light source may be used for exposure of the photothermographic material of the present invention, a laser ray is preferred. The laser for use in the present invention is preferably a gas laser (e.g., Ar⁺, He—Ne), a YAG laser, a dye laser or a semiconductor laser. Also, a semiconductor laser combined with a second harmonic generating device may be used. Of these, a red to infrared red emitting gas or semiconductor laser is preferred.

Examples of the medical-use laser imager equipped with an exposure section and a heat-development section include Fuji Medical Dry Laser Imager “FM-DP L” (trade name). The MF-DP L is described in Fuji Medical Review, No. 8, pp. 39-55 and it is needless to say that the technique described in this publication can be applied as a laser imager for the photothermographic material of the present invention. Furthermore, the photothermographic material of the present invention can also be used as that for a laser imager in the “AD network” which is proposed as a network system adaptable for the DICOM standard from Fuji Medical System.

The photothermographic material of the present invention forms a black-and-white image by the silver image so that it is preferably used as a photothermographic material for medical diagnosis, industrial photography, printing or COM.

### EXAMPLES

The present invention will hereinafter be described in detail by Examples. It should however be borne in mind that the present invention is not limited to or by them.

### Example 1

(Preparation of PET Support)

After sufficient vacuum drying of polyethylene terephthalate (which will hereinafter be abbreviated as “PET”) pellets having 16% by mass of titanium oxide finely-dispersed therein and having an intrinsic viscosity of 0.62, they were fed to an extruder heated to 280° C. They were extruded as a sheet from its T-slot. The resulting sheet was wound around a mirror-face casting drum having a surface temperature of 30° C. by electrostatic casting method to solidify the sheet by cooling, whereby an unstretched PET film was prepared.

This film was stretched to 3.3 times in the machine direction using rolls different in the peripheral speed and then stretched to 4.5 times in the transverse direction by a tenter. At this time, the temperatures were 110° C. and 130° C., respectively. The film was then heat set at 240° C. for 20 seconds and relaxed by 4% in the transverse direction at the same temperature. Thereafter, the chuck part of the tenter was released, both edges of the film were knurled, and the film was taken up at 4 kg/cm² to obtain a roll having a thickness of 175 μm.

(Surface Corona Treatment)

Both surfaces of the support were treated at room temperature at 20 m/min by using a solid state corona treating machine “Model 6KVA” (trade name; product of Pillar Technologies). The current and voltage indicated by the machine revealed that the support underwent the treatment of 0.375 kV·A·min/m² at that time. The treatment frequency here was 9.6 kHz and the gap clearance between the electrode and the dielectric roll was 1.6 mm.

(Preparation of Undercoated Support)

(1) Preparation of Coating Solution for Undercoat Layer Formulation (1) (for undercoat layer on the photosensitive layer side):

| | | |
|---|---|---|
| “PESRESIN A-520” (trade name; 30% by mass solution) | 59 | g |
| product of Takamatsu Yushi K.K. | | |
| Polyethylene glycol monononylphenyl ether (average | 5.4 | g |
| ethylene oxide number: 8.5), 10% by mass solution | | |
| “MP-1000” (fine polymer particles, average particle size: | 0.91 | g |
| 0.4 μm) produced by Soken Kagaku K.K. | | |
| Distilled water | 935 | ml |
| Formulation (2) (for first layer on the back surface): | | |
| Styrene/butadiene copolymer latex (solid content: 40% by | 158 | g |
| mass, a styrene/butadiene weight ratio: 68:32) | | |
| 2,4-Dichloro-6-hydroxy-S-triazine sodium salt, 8% by mass | 20 | g |
| aqueous solution | | |
| 1% By mass aqueous solution of sodium lauryl benzene | 10 | ml |
| sulfonate | | |
| Distilled water | 854 | ml |
| Formulation (3) (for second layer on the back surface): | | |
| SnO₂/SbO (9/1 by mass, average particle size: 0.038 μm, | 84 | g |
| 17% by mass dispersion) | | |
| Gelatin (10% by mass aqueous solution) | 89.2 | g |
| “METROSE TC-5” (trade name; 2% by mass aqueous | 8.6 | g |
| solution) product of Shin-Etsu Chemical Co., Ltd. | | |
| “MP-1000” (trade name) product of Soken Kagaku K.K. | 0.01 | g |
| 1% By mass aqueous solution of sodium dodecyl benzene | 10 | ml |
| sulfonate | | |
| NaOH (1% by mass) | 6 | ml |
| “PROXEL” (trade name; product of ICI) | 1 | ml |
| Distilled water | 805 | ml |

Both surfaces of the 175 μm-thick biaxially stretched polyethylene terephthalate support obtained above was each subjected to the above-described corona discharge treatment and on one surface (photosensitive layer surface), the undercoat coating solution of formulation (1) was applied by a wire bar to have a wet coating quantity of 6.6 ml/m² (per one surface) and dried at 180° C. for 5 minutes. On the opposite side thereof (back surface), the undercoat coating solution of formulation (2) was then applied by a wire bar to have a wet coating quantity of 5.7 ml/m² and dried at 180° C. for 5 minutes. Furthermore, onto the opposite side (back surface), the undercoat coating solution of formulation (3) was applied by a wire bar to have a wet coating quantity of 7.7 ml/m² and dried at 180° C. for 6 minutes, thereby obtaining an undercoated support.

(Preparation of Coating Solution for Back Surface)

In a container kept at 40° C., 50 g of gelatin, 0.2 g of sodium polystyrenesulfonate, 2.4 g of N,N-ethylenebis-(vinylsulfonacetamide), 1 g of sodium t-octylphenoxy-ethoxyethanesulfonate, 30 mg of benzisothazolinone, 37 mg of a fluorine surfactant (F-1: N-perfluorooctylsulfonyl-N-propylalanine potassium salt), 150 m g of a fluorine surfactant (F-2: polyethylene glycol mono (N-perfluorooctylsulfonyl-N-propyl-2-aminoethyl) ether [ethylene oxide average polymerization degree: 15]), 64 mg of a fluorine surfactant (F-3), 32 mg of a fluorine surfactant (F-4), 10 mg of a fluorine surfactant (F-7), 5 mg of a fluorine surfactant (F-4), 8.8 g of an acrylic acid/ethyl acrylate copolymer (copolymerization weight ratio: 5/95), 0.6 g of “Aerosol OT” (trade name; product of American Cyanamide) and 1.8 g, as liquid paraffin, of a liquid paraffin emulsion and 950 ml of water were mixed to prepare a coating solution for the protective layer on the back surface.

(Preparation of a Dye Dispersion)

An aqueous slurry of Dye 1 was obtained by stirring 9 g of Dye 1 and 2241 mL of distilled water in a high-speed stirrer (“Multidisperser PB95”, round blade type, product of SMT Co., Ltd.). A 10% aqueous solution (2500 mL) of gelatin was added under stirring to the aqueous slurry and they were mixed at 40° C. under stirring for 30 minutes. The resulting gelatin dispersion of Dye 1 was filtered through a polypropylene filter having an effective pore size of 3 μm and the filtrate was stored in a cool and dark place at 10° C. or less, whereby a jelly-like solid was obtained.

(Preparation of an Antihalation Layer)

In water was dissolved 54 g of inert gelatin and thereto, 60 g of a 27.5% by mass solution of methyl methacrylate/styrene/butyl acrylate/hydroxyethyl methacrylate/acrylic acid copolymer (copolymerization weight ratio: 64/9/20/5/2) latex, 200 g of the above dye dispersion, 5 ml of a 5% by mass aqueous solution of “Aerosol OT” (trade name; product of American Cyanamide), 0.5 g of phenoxyethanol, 0.1 g of benzisothiazolinone and water for making a total amount of 750 g were added to prepare a coating solution. The coating solution was transferred to a coating die to give a coverage of 18.6 ml/m².

The viscosity of the coating solution measured by a B-Type viscometer at 40° C. (No. 1 rotor, 60 rpm) was 30 [mPa·s].

(Preparation of a Silver Halide Emulsion)

<Preparation of Silver Halide Emulsion 1>

A solution was obtained by adding 3.1 ml of a 1% by mass potassium bromide solution, 3.5 ml of sulfuric acid in a concentration of 0.5 mol/L and 31.7 g of phthalized gelatin to 1,421 ml of distilled water. While stirring the solution in a stainless steel-made reaction pot and thereby keeping the liquid temperature at 30° C., the entire amount of Solution A obtained by diluting 22.22 g of silver nitrate to 95.4 ml with distilled water and the entire amount of Solution B obtained by diluting 15.3 g of potassium bromide and 0.8 g of potassium iodide to 97.4 ml with distilled water were added to the reaction pot at a constant flow rate over 45 seconds. To the resulting mixture were added 10 ml of a 3.5% by mass aqueous hydrogen peroxide solution and 10.8 ml of a 10% by mass aqueous solution of benzimidazole. The whole amount of Solution C obtained by diluting 51.86 g of silver nitrate to 317.5 ml with distilled water was added at a fixed flow rate over 20 minutes and Solution D obtained by diluting 44.2 g of potassium bromide and 2.2 g of potassium iodide to 400 ml with distilled water was added by a controlled double jet method while controlling the pAg at 8.1. Ten minutes after the initiation of the addition of Solution C and Solution D, the entire amount of potassium hexachloroiridate(III) was added in an amount of 1×10⁻⁴ mol per mol of silver. Also, 5 seconds after the completion of addition of Solution C, 3×10⁻⁴ mol, per mol of silver, of an aqueous potassium hexacyanoferrate(II) solution was added. Then, the pH was adjusted to 3.8 with 0.5 mol/L of sulfuric acid and after stirring was stopped, the solution was subjected to precipitation/desalting/water washing steps. Furthermore, the pH was adjusted to 5.9 with 1 mol/L of sodium hydroxide, whereby a silver halide dispersion at a pAg of 8.0 was prepared.

While stirring the silver halide dispersion obtained above and keeping its temperature at 38° C., 5 ml of a methanol solution containing 0.34% by mass of 1,2-benzisothiazolin-3-one was added. After 40 minutes, a methanol solution containing Spectral Sensitizing Dye A and Spectral Sensitizing Dye B at a molar ratio of 1:1 was added in an amount of 1.2×10⁻³ mol as a total of Spectral Sensitizing Dyes A and B per mol of silver. After 1 minute, the mixture was heated to 47° C. Twenty minutes after heating, a methanol solution of sodium benzenethiosulfate was added in an amount of 7.6×10⁻⁵ mol per mol of silver. After 5 minutes, a methanol solution of Tellurium Sensitizer C was added in an amount of 2.9×10⁻⁴ mol per mol of silver, followed by ripening for 91 minutes. To the resulting mixture was added 1.3 ml of a 0.8% by mass methanol solution of N,N′-dihydroxy-N″-diethylmelamine. After 4 minutes, a methanol solution of 5-methyl-2-mercaptobenzimidazole and a methanol solution of 1-phenyl-2-heptyl-5-mercapto-1,3,4-triazole were added in amounts of 4.8×10⁻³ mol and 5.4×10⁻³ mol, respectively, per mol of silver to prepare Silver Halide Emulsion 1.

The grains in the silver halide emulsion prepared were silver bromoiodide grains having an a average equivalent-sphere diameter of 0.042 μm and a coefficient of variation in the sphere-equivalent diameter of 20% and uniformly containing 3.5 mol % of iodide. The grain size and the like were determined as an average of 1,000 grains using an electron microscope. The percentage of {100} face in this grain was calculated as 80% in accordance with the Kubelka-Munk equation.

<Preparation of Silver Halide Emulsion 2>

In a similar manner to that employed for the preparation of Silver Halide Emulsion 1 except that the liquid temperature upon grain formation was changed from 30° C. to 47° C., Solution B was obtained by diluting 15.9 g of potassium bromide to 97.4 ml with distilled water, Solution D was obtained by diluting 45.8 g of potassium bromide to 400 ml with distilled water, Solution C was added over 30 minutes and potassium hexacyanoferrate(II) was excluded, preparation of Silver halide emulsion 2 was started. The solution thus obtained was subjected to precipitation, desalting, water washing and dispersion as in the preparation of Silver Halide Emulsion 1. In a similar manner to that employed for Emulsion 1 except that the amount of the methanol solution containing Spectral Sensitizing Dye A and Spectral Sensitizing Dye B at a molar ratio of 1:1 was changed to 7.5×10⁻⁴ mol as a total amount of Spectral Sensitizing Dyes A and B per mol of silver, the amount of Tellurium Sensitizer C was changed to 1.1×10⁻⁴ mol per mol of silver and the amount of 1-phenyl-2-heptyl-5-mercapto-1,3,4-triazole was changed to 3.3×10⁻³ mol per mol of silver, the spectral sensitization, the chemical sensitization, the addition of 5-methyl-2-mercaptobenzimidazole and 1-phenyl-2-heptyl-5-mercapto-1,3,4-triazole were performed, whereby Silver halide emulsion 2 was obtained. The emulsion grains of Silver Halide Emulsion 2 were pure silver bromide cubic grains having an equivalent-sphere diameter of 0.080 μm and a coefficient of variation in the equivalent-sphere diameter of 20%.

<Preparation of Silver Halide Emulsion 3>

In a similar manner to that employed for the preparation of Silver Halide Emulsion 1 except that the liquid temperature upon grain formation was changed from 30° C. to 27° C., preparation of Silver Halide Emulsion 3 was started. The solution thus obtained was subjected to precipitation, desalting, water washing and dispersion as in the preparation of Silver Halide Emulsion 1. Silver Halide Emulsion 3 was then obtained in a similar manner to that employed for the preparation of Silver Halide Emulsion 1 except that the amount of the solid dispersion (aqueous gelatin solution) containing Spectral Sensitizing Dye A and Spectral Sensitizing Dye B at a molar ratio of 1:1 was changed to 6×10⁻³ mol as a total amount of Spectral Sensitizing Dyes A and B per mol of silver and the amount of Tellurium Sensitizer C was changed to 5.2×10⁻⁴ mol per mol of silver. The emulsion grains of Silver Halide Emulsion 3 thus obtained were silver bromoiodide grains having an equivalent-sphere diameter of 0.034 μm and a coefficient of variation in the equivalent-sphere diameter, of 20% and uniformly containing 3.5 mol % of iodide.

<Preparation of Mixed Emulsion A for Coating Solution>

Silver Halide Emulsion 1 (70% by mass), Silver Halide Emulsion 2 (15% by mass) and Silver Halide Emulsion 3 (15% by mass) were dissolved, followed by the addition thereto of a 1% by mass aqueous solution of benzothiazolium iodide in an amount of 7×10⁻³ mol per mol of silver. Water was then added to make a silver halide content of 38.2 g as silver per kg of the mixed emulsion for the coating solution.

<Preparation of Fatty Acid Silver Salt Dispersion>

Behenic acid (“Edenor C22-85R”, trade name; product of Henkel Corp., 87.6 Kg), 423 L of distilled water, 49.2 L of a 5 mol/L aqueous NaOH solution and 120 L of t-butyl alcohol were mixed. The mixture was reacted by stirring at 75° C. for 1 hour to prepare a sodium behenate solution. Separately, 206.2 L of an aqueous solution (pH 4.0) of 40.4 Kg of silver nitrate was prepared and maintained at 10° C. A reaction vessel containing 635 L of distilled water and 30 L of t-butyl alcohol were maintained at 30° C., and added with the entire amounts of the sodium behenate solution and the aqueous silver nitrate solution at constant flow rates over 93 minutes and 15 seconds, and 90 minutes, respectively. In this process, only the aqueous silver nitrate solution was added for first 11 minutes after the initiation of the addition of the aqueous silver nitrate solution, then addition of the sodium behenate solution was started. For 14 minutes and 15 seconds after the completion of the addition of the aqueous silver nitrate solution, only the sodium behenate solution was added. During this procedure, the temperature inside the reaction vessel was kept at 30° C., and the outside temperature was controlled so that the temperature of the mixture should be fixed. A piping in a feeding system of the sodium behenate solution was kept warm by circulating hot water in an outer portion of the double pipe, whereby the outlet liquid temperature at the end of the feed nozzle was adjusted to 75° C. A piping in a feeding system of the aqueous silver nitrate solution, on the other hand, was kept warm by circulating cold water in an outer portion of the double pipe. Positions of addition of the sodium behenate solution and aqueous silver nitrate solution were symmetrically arranged centered around a stirring axis, the heights of which being adjusted so as to avoid contact to the reaction solution.

After completion of the addition of the sodium behenate solution, the mixture was left at that temperature for 20 minutes under stirring. The reaction mixture was then heated to 35° C. over 30 minutes, followed by ripening for 210 minutes. Rightly after completion of the ripening, the solid content was filtered out by centrifugal filtration, and washed with water until the conductivity of the filtrate became 30 μS/cm. In this manner, a fatty acid silver salt was obtained. The solid content thus obtained was not dried but stored as a wet cake.

The shape of the resulting silver behenate grains was analyzed by electron microphotography. The grains were scaly crystals having the following average size: a=0.14 μm, b=0.4 μm and c=0.6 μm, an average aspect ratio of 5.2, average sphere-equivalent diameter of 0.52 μm and an average sphere-equivalent coefficient of variation of 15% (a, b and c comply with the definition in this specification).

To 260 Kg, in terms of a dry solid content, of the wet cake, 19.3 K g of polyvinyl alcohol (“PVA-217”, trade name) and water were added to make the total amount of 1000 Kg. The resulting mixture was made into a slurry by a dissolver blade, followed by preliminary dispersion by a pipeline mixer (“Model PM-10”, trade name; product of Mizuho Kogyo).

Then, the preliminarily dispersed stock solution was treated three times in a dispersing machine (“Microfluidizer M-610”, trade name; product of Microfluidex International Corporation, using a Z type interaction chamber) under a pressure controlled to 1,260 kg/cm², whereby a silver behenate dispersion was obtained. Cooling operation was conducted by controlling the temperature of the coolant by coiled heat exchangers attached to the inlet side and outlet side of the interaction chamber, whereby the dispersion temperature was set at 18° C.

(Preparation of Reducing Agent Dispersion)

<Preparation of Reducing Agent Complex-1 Dispersion>

To 10 Kg of Reducing Agent Complex-1 (a 1:1 complex of 6,6′-di-t-butyl-4,4′-dimethyl-2,2′-butylidenediphenol and triphenylphosphine oxide), 0.12 kg of triphenylphosphine oxide and 16 Kg of a 10% by mass aqueous solution of modified polyvinyl alcohol (“Poval MP203”, trade name; product of Kuraray Co., Ltd.), 10 Kg of water was added, followed by thorough mixing to form a slurry. The resulting slurry was sent by a diaphragm pump and dispersed in a horizontal sand mill (“UVM-2”, trade name; manufactured by AIMEX K.K.) filled with zirconia beads having an average diameter of 0.5 mm for 4 hours and 30 minutes. Thereafter, 0.2 g of benzisothiazolinone sodium salt and water were added to adjust the reducing agent concentration to 22% by mass, thereby obtaining Reducing Agent Complex-1 Dispersion. The reducing agent complex particles contained in the thus-obtained Reducing Agent Complex Dispersion had a median diameter of 0.45 μm and a maximum particle size of 1.4 μm or less. The resulting Reducing Agent Complex Dispersion was filtered through a polypropylene filter having a pore size of 3.0 μm to remove foreign matters such as dust and then housed.

<Preparation of Reducing Agent-2 Dispersion>

To 10 kg of Reducing Agent-2 (6,6′-di-t-butyl-4,4′-dimethyl-2,2′-butylidenediphenol) and 16 Kg of a 10% by mass aqueous solution of modified polyvinyl alcohol (“Poval MP203”, trade name; product of Kuraray Co., Ltd.), 10 Kg of water was added, followed by thorough mixing to form a slurry. The resulting slurry was sent by a diaphragm pump and dispersed in a horizontal sand mill (“UVM-2”, trade name; manufactured by AIMEX K.K.) filled with zirconia beads having an average diameter of 0.5 mm for 3 hours and 30 minutes. To the resulting dispersion, 0.2 g of benzisothiazolinone sodium salt and water were added to adjust the reducing agent concentration to 25% by mass, thereby obtaining Reducing Agent-2 Dispersion. The reducing agent particles contained in the resulting Reducing Agent-2 Dispersion had a median diameter of 0.40 μm and a maximum particle size of 1.5 μm or less. The resulting Reducing Agent Dispersion was filtered through a polypropylene filter having a pore size of 3.0 μm to remove foreign matters such as dust and then housed.

<Preparation of Hydrogen Bond Forming Compound-1 Dispersion>

To 10 Kg of Hydrogen Bond Forming Compound-1 (tri(4-t-butylphenyl)phosphine oxide) and 16 Kg of a 10% by mass aqueous solution of modified polyvinyl alcohol (“Poval MP203”, trade name; product of Kuraray Co., Ltd.), 10 Kg of water was added, followed by thorough mixing to form a slurry. The resulting slurry was sent by a diaphragm pump and dispersed in a horizontal sand mill (“UVM-2”, trade name; manufactured by AIMEX K.K.) filled with zirconia beads having an average diameter of 0.5 mm for 3 hours and 30 minutes. Thereafter, 0.2 g of benzisothiazolinone sodium salt and water were added to adjust the hydrogen bond forming compound concentration to 25% by mass, thereby obtaining Hydrogen Bond Forming Compound-1 Dispersion. The hydrogen bond forming compound particles contained in the hydrogen bond forming compound dispersion thus obtained had a median diameter of 0.35 μm and a maximum particle size of 1.5 μm or less. The hydrogen bond forming compound dispersion was filtered through a polypropylene filter having a pore size of 3.0 μm to remove foreign matters such as dust and then housed.

(Preparation of Development Accelerator-1 Dispersion)

<Preparation of Development Accelerator-1 Dispersion>

To 10 Kg of Development Accelerator-1 and 20 Kg of a 10% by mass aqueous solution of modified polyvinyl alcohol (“Poval MP203”, trade name; product of Kuraray Co., Ltd.), 10 Kg of water was added. They were thoroughly mixed to form a slurry. The resulting slurry was sent by a diaphragm pump and dispersed in a horizontal sand mill (“UVM-2”, trade name; manufactured by AIMEX K.K.) filled with zirconia beads having an average diameter of 0.5 mm for 3 hours and 30 minutes. To the resulting dispersion, 0.2 g of benzisothiazolinone sodium salt and water were added to adjust the development accelerator concentration to 20% by mass, thereby obtaining Development Accelerator-1 Dispersion. The development accelerator particles contained in the thus-obtained development accelerator dispersion had a median diameter of 0.48 μm and a maximum particle size of 1.4 μm or less. The resulting development accelerator dispersion was filtered through a polypropylene filter having a pore size of 3.0 μm to remove foreign matters such as dust and then housed.

<Preparation of a Dispersion of Development Accelerator-2, -3, etc.>

In a similar manner to that employed for the preparation of Development Accelerator-1, Development Accelerator-2, Development Accelerator-3 and Color-tone Adjuster-1, 20% by mass solid dispersions were obtained, respectively.

(Preparation of Polyhalogen Compounds)

<Preparation of Organic Polyhalogen Compound-1 Dispersion>

To 10 Kg of Organic Polyhalogen Compound-1 (tribromomethanesulfonylbenzene), 10 Kg of a 20% by mass aqueous solution of modified polyvinyl alcohol (“Poval MP203”, trade name; product of Kuraray Co., Ltd.), 0.4 Kg of a 20% by mass aqueous solution of sodium triisopropyl-naphthalenesulfonate, 14 Kg of water was added. They were thoroughly mixed to form a slurry. The resulting slurry was sent by a diaphragm pump and dispersed in a horizontal sand mill (“UVM-2”, trade name; manufactured by AIMEX K.K.) filled with zirconia beads having an average diameter of 0.5 mm for 5 hours. Then, 0.2 g of benzisothiazolinone sodium salt and water were added to adjust the concentration of the organic polyhalogen compound to 26% by mass, thereby obtaining Organic Polyhalogen Compound-1 Dispersion. The organic polyhalogen compound particles contained in the resulting Organic Polyhalogen Compound-1 Dispersion had a median diameter of 0.41 μm and a maximum particle size of 2.0 μm or less. The Organic Polyhalogen Compound Dispersion was filtered through a polypropylene filter having a pore size of 10.0 μm to remove foreign matters such as dust and then housed.

<Preparation of Organic Polyhalogen Compound-2 Dispersion>

To 10 Kg of Organic Polyhalogen Compound-2 (N-butyl-3-tribromomethanesulfonylbenzoamide) and 20 Kg of a 10% by mass aqueous solution of modified polyvinyl alcohol (“Poval MP203”, trade name; product of Kuraray Co., Ltd.), 0.4 Kg of a 20% by mass aqueous solution of sodium triisopropylnaphthalenesulfonate was added. They were thoroughly mixed to form a slurry. The resulting slurry was sent by a diaphragm pump and dispersed in a horizontal sand mill (“UVM-2”, trade name; manufactured by AIMEX K.K.) filled with zirconia beads having an average diameter of 0.5 mm for 5 hours. Then, 0.2 g of benzisothiazolinone sodium salt and water were added to adjust the concentration of the organic polyhalogen compound to 30% by mass. The dispersion was heated at 40° C. for 5 hours, whereby Organic Polyhalogen Compound-2 Dispersion was obtained. The organic polyhalogen compound particles contained in the polyhalogen compound dispersion thus obtained had a median diameter of 0.40 μm and a maximum particle size of 1.3 μm or less. The resulting organic polyhalogen compound dispersion was filtered through a polypropylene filter having a pore size of 3.0 μm to remove foreign matters such as dust and then housed.

<Preparation of Phthalazine Compound-1 Solution>

In 174.57 Kg of water was dissolved 8 Kg of modified polyvinyl alcohol “MP203” (trade name; product of Kuraray Co., Ltd.). To the resulting solution were added 3.15 Kg of a 20% by mass aqueous solution of sodium triisopropylnaphthalenesulfonate and 14.28 Kg of a 70% by mass aqueous solution of Phthalazine Compound-1 (6-isopropylphthalazine) to prepare a 5% by mass solution of Phthalazine Compound-1.

(Preparation of Mercapto Compound)

<Preparation of Aqueous Mercapto Compound-1 Solution>

In 993 g of water was dissolved 7 g of Mercapto Compound-1 (1-(3-sulfophenyl)-5-mercaptotetrazole sodium salt) to prepare a 0.7% by mass aqueous solution.

<Preparation of Aqueous Mercapto Compound-2 Solution>

In 980 g of water was dissolved 20 g of Mercapto Compound-2 (1-(3-methylureido)-5-mercaptotetrazole sodium salt) to prepare a 2.0% by mass aqueous solution.

(Preparation of Pigment-1 Dispersion)

To 250 g of water were added 6.4 g of C.I. Pigment Blue 60 and 6.4 g of “DEMOL N” (trade name; product of Kao Corporation). They were thoroughly mixed into a slurry. The resulting slurry and 800 g of zirconia beads having an average diameter of 0.5 mm were charged together in a vessel and dispersed for 25 hours in a dispersing machine (¼ G sand grinder mill: manufactured by AIMEX K.K.), whereby Pigment-1 Dispersion was prepared. The pigment particles contained in the resulting pigment dispersion had an average particle size of 0.21 μm.

<Preparation of SBR Latex Solution>

An SBR latex having a Tg of 22° C. was prepared in the below-described manner.

Using ammonium persulfate as a polymerization initiator and an anionic surfactant as an emulsifier; 70.0 mass of styrene, 27.0 mass of butadiene and 3.0 mass of acrylic acid were emulsion-polymerized, followed by aging at 80° C. for 8 hours. The resulting solution was then cooled to 40° C. and adjusted to pH 7.0 with aqueous ammonia. “SANDET BL” (trade name; product of Sanyo Kasei K.K.) was added to the solution to give a concentration of 0.22%. The resulting mixture was adjusted to pH 8.3 with an aqueous 5% sodium hydroxide solution and then, pH 8.4 with aqueous ammonia. At this time, Na⁺ ions and NH₄⁺ ions were used at a molar ratio of 1:2.3. To 1 Kg of this solution, 0.15 ml of a 7% aqueous solution of benzoisothiazolinone sodium salt was added to prepare an SBR latex solution. The resulting latex dispersion has the following properties.

(SBR Latex: latex of -St(70.0)-Bu(27.0)-AA(3.0)-): Tg: 22° C., average particle size: 0.1 μm, concentration: 43% by mass, equilibrium moisture content at 25° C. and 60% RH: 0.6% by mass, ion conductivity: 4.2 mS/cm (the ion conductivity of the latex stock solution (43% by mass) was measured using a conductivity meter “CM-30S” (trade name; manufactured by Toa Denpa Kogyo K.K.) at 25° C.), pH: 8.4 (as a stock solution).

SBR latices having different Tg were prepared in a similar manner by changing a styrene:butadiene ratio as needed.

(Preparation of Coating Solution for Each layer Constituting Image Forming Layer)

<Preparation of Coating Solution-1 for Emulsion Layer (Photosensitive Layer)>

The fatty acid silver salt dispersion prepared above (1,000 g), 276 ml of water, 33.2 g Pigment-1 Dispersion, 21 g of Organic Polyhalogen Compound-1 Dispersion, 58 g of Organic Polyhalogen Compound-2 Dispersion, 173 g of Phthalazine Compound-1 Solution, 1,082 g of SBR latex (Tg: 22° C.) solution, 299 g of Reducing Agent Complex-1 Dispersion, 6 g of Development Accelerator-1 Dispersion, 9 ml of Aqueous Mercapto Compound-1 Solution, and 27 ml of Aqueous Mercapto Compound-2 Solution were successively added. Immediately before coating, 117 g of Silver Halide Mixed Emulsion A was added and thoroughly mixed. The resulting coating solution for emulsion layer was sent as was to a coating die and coated.

As a result of measurement by a Brookfield viscometer manufactured by Tokyo Keiki Kogyo K.K., the coating solution for emulsion layer obtained above was found to have a viscosity of 25 [mpa·s] at 40° C. (No. 1 rotor, 60 rpm).

The viscosities of the coating solution measured at 25° C. using “RFS Field Spectrometer” (trade name; product of Rheometrics Far East K.K.) at shear rates of 0.1, 1, 10, 100 and 1,000 [1/sec] were found to be 230, 60, 46, 24 and 18 [mpa·s] respectively.

The amount of zirconium in the coating solution was 0.38 mg per g of silver.

<Preparation of Coating Solution-2 for Emulsion Layer (Photosensitive Layer)>

The fatty acid silver salt dispersion prepared above (1,000 g), 276 ml of water, 32.8 g of Pigment-1 Dispersion, 21 g of Organic Polyhalogen Compound-1 Dispersion, 58 g of Organic Polyhalogen Compound-2 Dispersion, 173 g of Phthalazine Compound-1 Solution, 1,082 g of SBR latex (Tg: 20° C.) solution, 155 g of Reducing Agent-2 Dispersion, 55 g of Hydrogen Bond Forming Compound-1 Dispersion, 6 g of Development Accelerator-1 Dispersion, 2 g of Development Accelerator-2 Dispersion, 3 g of Development Accelerator-3 Dispersion, 2 g of Color-tone Adjuster-1 Dispersion, and 6 ml of Aqueous Mercapto Compound-2 Solution were successively added. Immediately before coating, 117 g of Silver Halide Mixed Emulsion A was added and they were thoroughly mixed. The resulting coating solution for emulsion layer was sent as was to a coating die and coated.

The viscosity of the coating solution for emulsion layer obtained above as measured by a Brookfield viscometer manufactured by Tokyo Keiki Kogyo K.K. was found to be 40 [mPa·s] at 40° C. (No. 1 rotor, 60 rpm).

The viscosities of the coating solution measured at 25° C. using “RFS Field Spectrometer” (trade name; product of Rheometrics Far East K.K.) at shear rates of 0.1, 1, 10, 100 and 1,000 [1/sec] were found to be 530, 144, 96, 51 and 28 [mPa·s], respectively.

The amount of zirconium in the coating solution was 0.25 mg per g of silver.

<Preparation of Coating Solution for Interlayer on Emulsion Surface>

To 1000 g of polyvinyl alcohol “PVA-205” (trade name; product of Kuraray Co., Ltd.), 272 g of a 5% by mass dispersion of pigment and 4200 ml of a 19% by mass solution of methyl methacrylate/styrene/butyl acrylate/hydroxyethyl methacrylate/acrylic acid copolymer (copolymerization weight ratio: 64/9/20/5/2) latex, were added 27 ml of a 5% by mass aqueous solution of “Aerosol OT” (trade name; product of American Cyanamide), 135 ml of a 20% by mass aqueous solution of diammonium phthalate and water for making a total amount of 10000 g. The resulting mixture was adjusted to pH 7.5 with NaOH, whereby a coating solution for interlayer was prepared. The solution thus obtained was then sent to a coating die to give a coverage of 7.3 ml/m².

The viscosity of the coating solution as measured at 40° C. by a Brookfield viscometer (No. 1 rotor, 60 rpm) was 58 [mPa·s].

<Preparation of Coating Solution for First Protective Layer on Emulsion Surface>

In water was dissolved 64 g of inert gelatin. To the resulting solution were added 80 g of a 27.5% by mass solution of methyl methacrylate/styrene/butyl acrylate/hydroxyethyl methacrylate/acrylic acid copolymer (copolymerization weight ratio: 64/9/20/5/2) latex, 23 ml of a 10% by mass methanol solution of phthalic acid, 23 ml of a 10% by mass aqueous solution of 4-methylphthalic acid, 28 ml of 0.5 mol/L sulfuric acid, 5 ml of a 5% by mass aqueous solution of Aerosol OT (produced by American Cyanamide), 0.5 g of phenoxyethanol, 0.1 g of benzisothiazolinone and water for making a total amount of 750 g to prepare a coating solution. Immediately before coating, 26 ml of a 4% by mass chrome alum was mixed with the resulting solution in a static mixer and the resulting mixture was sent to a coating die to give a coverage of 13.0 ml/m².

The viscosity of the coating solution as measured by a Brookfield viscometer at 40° C. (No. 1 rotor, 60 rpm) was 20 [mPa·s].

<Preparation of Coating Solution for the Second Protective Layer on Emulsion Surface>

80 g of inert gelatin was dissolved in water. To the resulting solution were added 60 g of a 27.5% by mass solution of methyl methacrylate/styrene/butyl acrylate/hydroxyethyl methacrylate/acrylic acid copolymer (copolymerization weight ratio: 64/9/20/5/2) latex, 3.2 ml of a 5% by mass solution of fluorine-containing surfactant (F-1: N-perfluorooctylsulfonyl-N-propylalanine potassium salt), 32 ml of a 2% by mass aqueous solution of fluorine-containing surfactant (F-2: polyethylene glycol mono(N-perfluorooctylsulfonyl-N-propyl-2-aminoethyl ether [ethylene oxide average polymerization degree: 15]), 23 ml of a 5% solution of “Aerosol OT” (trade name; product of American Cyanamide), 0.5 g of polymethyl methacrylate fine particles (average particle size: 0.7 μm), 3 g of polymethyl methacrylate fine particles (average particle size: 4.5 μm), 1.6 g of 4-methylphthalic acid, 4.8 g of phthalic acid, 44 ml of 0.5 mol/L of sulfuric acid, 10 ml of benzoisothiazolinone and water for making a total amount of 650 g. Immediately before coating, 445 ml of an aqueous solution containing 4% by mass of chrome alum and 0.67% by mass of phthalic acid was mixed in a static mixer and the resulting coating solution for surface protective layer was sent to a coating die to give a coverage of 8.3 ml/m².

The viscosity of the coating solution as measured at 40° C. by a Brookfield viscometer (No. 1 rotor, 60 rpm) was 19 [mPa·s].

(Preparation of Photothermographic Materials)

<Preparation of Photothermographic Material-1>

On the back surface of the above-described undercoated support, the coating solution for antihalation layer and the coating solution for back surface protective layer were simultaneously coated such that the coating quantity, in terms of a solid content, of the solid fine-particle dye of the former coating solution would be 0.04 g/m² and gelatin coating quantity of the latter coating solutionr would be 1.7 g/m². The coating was then dried to form a back layer.

On the surface opposite to the back surface, an emulsion layer, an interlayer, a first protective layer and a second protective layer were simultaneously coated one after another in the order of mention from the undercoated surface by the slide bead coating method, whereby a photothermographic material sample was prepared. At this time, the temperature of each of the emulsion layer and the interlayer was adjusted to 31° C., that of the first protective layer was to 36° C. and that of the second protective layer was to 37° C.

The coating quantity (g/m²) of each compound in the emulsion layer is shown below.

| | |
|---|---|
| Silver behenate | 2.78 |
| Pigment (C.I. Pigment Blue 60) | 0.006 |
| Polyhalogen Compound-1 | 0.06 |
| Polyhalogen Compound-2 | 0.19 |
| Phthalazine Compound-1 | 0.10 |
| SBR Latex | 4.99 |
| Reducing Agent Complex-1 | 0.71 |
| Development Accelerator-1 | 0.012 |
| Mercapto Compound-1 | 0.001 |
| Mercapto Compound-2 | 0.006 |
| Silver Halide (as Ag) | 0.046 |

The coating and drying conditions were as follows.

The coating was performed at a speed of 160 m/min, the distance between the tip of coating die and the support was set at from 0.10 to 0.30 mm and the pressure in the vacuum chamber was set lower by 196 to 882 Pa than the atmospheric pressure. The support was destaticized by ionized wind before coating.

In the subsequent chilling zone, the coating solution was cooled by the air flow showing a dry bulb temperature of 10 to 20° C. The sample was then subjected to contact-free transportation and in a helical floating type dryer, was dried with drying air showing a dry bulb temperature of 23 to 45° C. and a wet bulb temperature of 15 to 21° C.

After drying, the humidity was adjusted to 40 to 60% RH at 25° C. and then, the layer surface was heated to 70 to 90° C. The heated layer surface was then cooled to 25° C.

The photothermographic material thus prepared had a matting degree of, in terms of the Beck's smoothness, 550 seconds on the photosensitive layer surface and 130 seconds on the back surface. Furthermore, the pH on the layer surface on the photosensitive layer side was measured and found to be 6.0.

<Preparation of Heat-development Photothermographic Material-2>

Photothermographic material 2 was prepared in a similar manner to that employed for the preparation of Photothermographic material 1 except that Coating Solution-1 for Emulsion Layer was changed to Coating Solution-2 for Emulsion Layer, Yellow Dye Compound 15 was removed from Antihalation Layer, the fluorine surfactant of the back surface protective layer and emulsion surface protective layer was changed from F-1, F-2, F-3 and F-4 to F-5, F-6, F-7 and F-8, respectively.

At this time, the coating quantity (g/m²) of each compound in the emulsion layer was as follows.

| | |
|---|---|
| Silver behenate | 2.78 |
| Pigment (C.I. Pigment Blue 60) | 0.006 |
| Polyhalogen Compound-1 | 0.06 |
| Polyhalogen Compound-2 | 0.19 |
| Phthalazine Compound-1 | 0.10 |
| SBR Latex | 4.84 |
| Reducing Agent-2 | 0.41 |
| Hydrogen Bond Forming Compound-1 | 0.15 |
| Development Accelerator-1 | 0.012 |
| Development Accelerator-2 | 0.005 |
| Development Accelerator-3 | 0.008 |
| Color-tone Adjuster-1 | 0.005 |
| Mercapto Compound-2 | 0.002 |
| Silver Halide (as Ag) | 0.046 |

The chemical structures of the compounds used in Examples of the present invention will next be shown.

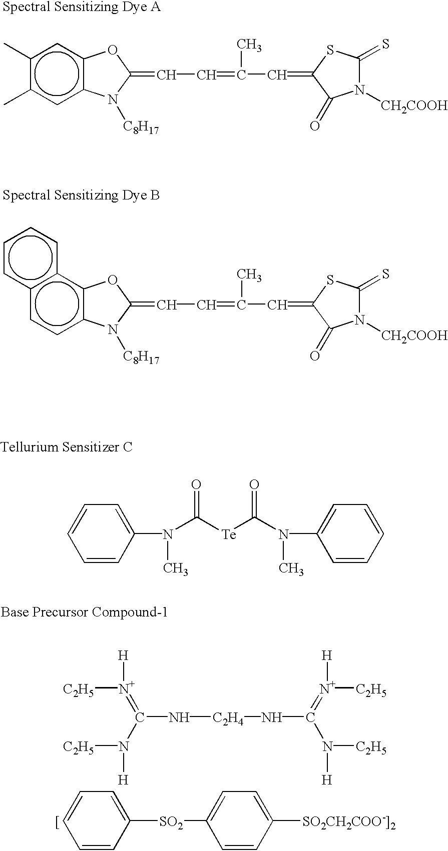

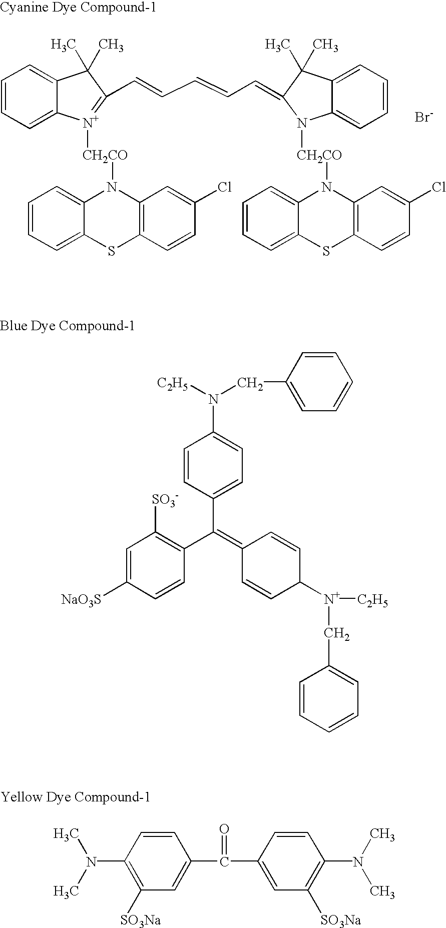

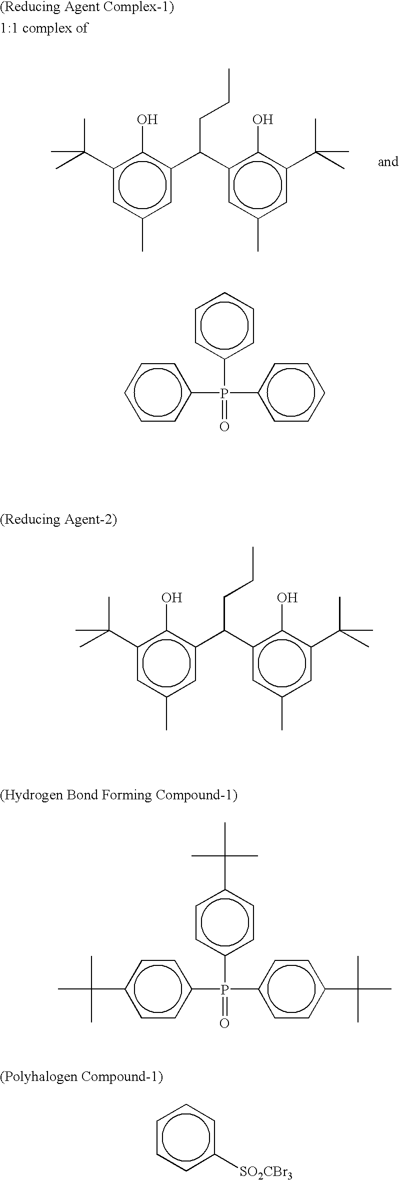

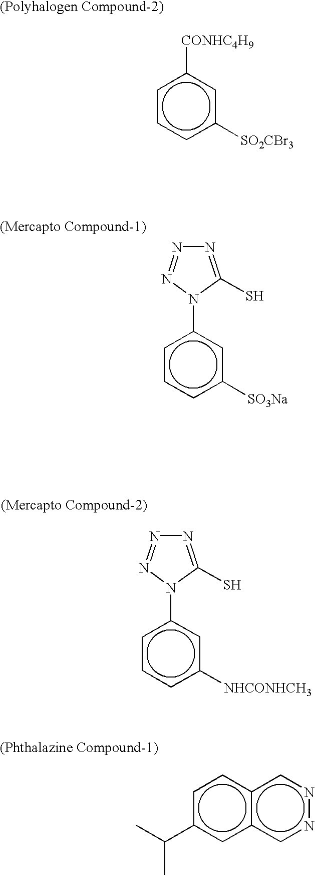

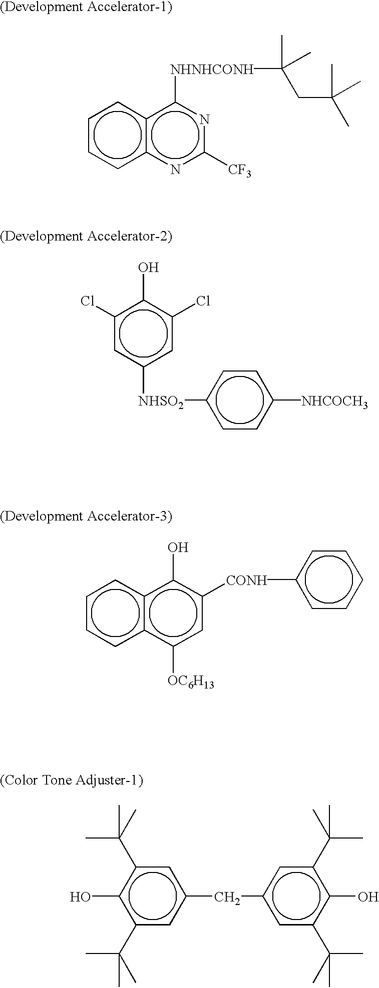

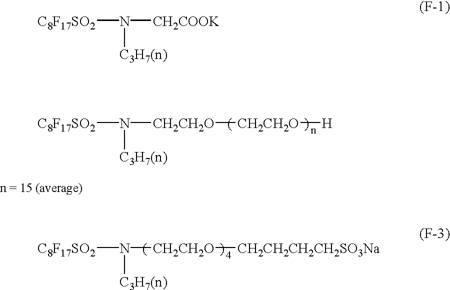

(F-4) C₈F₁₇SO₃K

(F-5) CF₃(CF₂)nCH₂CH₂SCH₂CH₂COOLi mixture of n=5 to 11

(F-6) CF₃(CF₂)nCH₂CH₂O(CH₂CH₂O)mH mixture of n=5 to 11, m=5 to 15

(F-7) CF₃(CF₂)nCH₂CH₂SO₃Na mixture of n=5 to 11

(F-8) C₆F₁₃CH₂CH₂SO₃Li

(Evaluation of Photographic Performance)

The sample thus obtained was cut into 356×432 mm and was wrapped with the below-described packaging material at 25° C. and 50% RH. After storage for 2 weeks at room temperature, the sample was evaluated.

(Packaging Material)

Employed was a laminate sheet material made of polyethylene (50 μm) containing 10 μm of PET, 12 μm of PE, 9 μm of aluminum foil, 15 μm of Ny, 3% of carbon and having the below-described gas and moisture permeabilities.

oxygen permeability: 0 ml/atm·m²·25° C.·day (0 mPa·deg·s),

moisture permeability: 0 g/atm·m²·25° C.·day (0 g/Pa·m²·deg·s)

The oxygen permeability or moisture permeability showing 0 means that no permeability is recognized as measured by a predetermined measuring method.

Each sample was exposed and heat-developed (Heat Development Photothermographic material-1 for 16 seconds in total and Heat Development Photothermographic material-2 for 10 seconds in total, with 4 sheets of panel heater set to 112° C.-119° C.-121° C.-121° C.) by Fuji Medical Dry Laser Imager FM-DP L (mounted with a 660 nm semiconductor laser having a maximum output of 60 mW (IIIB)). The image thus obtained was evaluated by a densitometer

The fog density of the non-image portion of the above-described Photothermographic material-1 was 0.18 and its maximum image density was 2.54, while the fog density of the Photothermographic material-2 was 0.17 and its maximum image density was 2.61.

Printing of an X-ray picture of the chest and CT image has revealed that a sharp and tight image was available.

For comparison, the same image was output using a commercially available printer, more specifically, “PM-3300” (trade name; product of Seiko Epson Corp.) and “Deskjet 1220C” (product of Hewlett Packard Company). Paper was exclusively used photographic paper recommended by each company. The image available using the photothermographic material of the present invention is markedly superior in sharpness and tightness.

### Example 2

(Preparation of Support)

On the surface of base paper 80 μm thick, 120 μm thick or 180 μm thick, a mixed composition of polyester (intrinsic viscosity=6.5) synthesized by condensation polymerization of a dicarboxylic acid composition and ethylene glycol or polyethylene, and titanium oxide (“KA-10”, trade name; product of Titanium Industry) was, after melt mixing in a twin-screw extruder at 300° C., melt extruded from a T die to form a laminate layer of 30 μm thick. On the other surface, a calcium-carbonate-containing resin composition was melt extruded at 300° C. to form a laminate layer of 30 μm thick. The resin surface on both sides of the reflective support having a laminate formed thereon was subjected to corona discharge treatment, followed by coating of a coating solution having the below-described composition to give a coated quantity of 5 cc/m². By drying at 80° C. for 2 minutes, a support for a photothermographic material was obtained.

[Undercoating formulation]

| | | |
|---|---|---|
| Compound ExU1 | 0.2 | g |
| Compound ExU2 | 0.001 | g |
| Dye 1 | 0.28 | g |
| H₂O | 35 | cc |
| Methanol | 65 | cc |
| Gelatin | 2 | g |
| pH 9.5 | | |

(Dye 1)

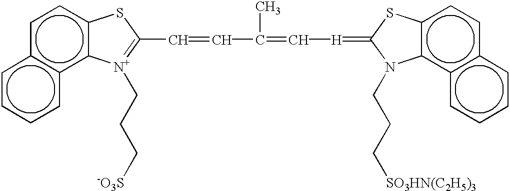

(ExU1)

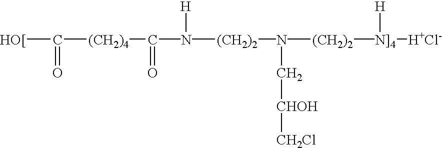

(ExU2)
C₁₂H₂₅O(CH₂CH₂O)₁₀H

TABLE 1

| | Thickness of | Resin (dicarboxylic acid | TiO₂ |
|---|---|---|---|
| Support | support | composition of polyester) | content (wt. %) |
| (1) | 60 μm | Polyethylene | 15% |
| (2) | 80 μm | Polyethylene | 20% |
| (3) | 80 μm | Polyester (terephthalic | 15% |
| | | acid/isophthalic acid = 90/10) | |
| (4) | 80 μm | Polyester (terephthalic | 20% |
| | | acid/isophthalic acid = 90/10) | |
| (5) | 120 μm | Polyester (terephthalic | 18% |
| | | acid/isophthalic acid = 90/10) | |
| (6) | 120 μm | Polyester (terephthalic | 15% |
| | | acid/isophthalic acid = 90/10) | |
| (7) | 120 μm | Polyester (terephthalic | 20% |
| | | acid/isophthalic acid 90/10) | |
| (8) | 120 μm | Polyester (terephthalic | 18% |
| | | acid/isophthalic acid = 85/15) | |
| (9) | 120 μm | Polyester (terephthalic | 18% |
| | | acid/isophthalic acid = 90/10) | |
| (10) | 120 μm | Polyester (terephthalic | 18% |
| | | acid/isophthalic acid = 95/5) | |
| (11) | 180 μm | Polyester (terephthalic | 18% |
| | | acid/isophthalic acid = 90/10) | |
| (12) | 180 μm | Polyester (terephthalic | 15% |
| | | acid/isophthalic acid = 90/10) | |
| (13) | 180 μm | Polyester (terephthalic | 20% |
| | | acid/isophthalic acid = 90/10) | |

In a similar manner to that employed for the preparation of Photothermographic material-1 or -2 in Example 1 except that the above-described supports shown in Table 1 were used, photothermographic materials were prepared. They were evaluated as in Example 1. In this Example, high quality reflective images were available as in Example 1.

In a similar manner to that employed for the preparation of Photothermographic material-2 of Example 1 except that the thickness of the support was changed to 120 μm and the silver coating quantity (g/m² as Ag) and the amount of a reducing agent (mmol/m²) were changed as shown in Table 2, photothermographic materials were prepared and they were evaluated for fog density at non-image portion and maximum image density. The results are shown in Table 2.

In this Example, high quality reflective images were available as in Example 1.

TABLE 2

| | Silver | Amount of | | |
|---|---|---|---|---|
| | coating | reducing | | |
| Sample | quantity | agent | Dmin | Dmax |
| (1) | 1.2 | 1.5 | 0.22 | 2.68 |
| (2) | 1.05 | 1.5 | 0.20 | 2.63 |
| (3) | 0.9 | 1.5 | 0.18 | 2.58 |
| (4) | 0.75 | 1.5 | 0.17 | 2.54 |
| (5) | 0.6 | 1.5 | 0.16 | 2.48 |
| (6) | 0.75 | 2.2 | 0.21 | 2.55 |
| (7) | 0.75 | 1.8 | 0.20 | 2.58 |
| (8) | 0.75 | 1.3 | 0.16 | 2.52 |
| (9) | 0.95 | 1.2 | 0.18 | 2.61 |
| (10) | 1.2 | 1.2 | 0.21 | 2.56 |
| (11) | 0.7 | 2.1 | 0.20 | 2.48 |
| (12) | 0.7 | 1.4 | 0.17 | 2.44 |

### Example 4

In a similar manner to that employed in Example 1 for the preparation of Photothermographic material-1 except that the thickness of the support was changed to 120 μm and the kind and coating quantity (g/m²) of a polyhalogen compound were changed as shown in Table 3, photothermographic materials as shown in Table 3 were prepared and evaluation was conducted as in Example 1. The results are shown in Table 3.

In this Example, high quality reflective images were available as in Example 1.

TABLE 3

| | Kind of | | | |
|---|---|---|---|---|
| Sample | polyhalogen | Amount | Dmin | Dmax |
| (1) | H-1/H-8 | 0.06/0.19 | 0.17 | 2.54 |
| (2) | H-1/H-8 | 0.12/0.15 | 0.17 | 2.55 |
| (3) | H-1 | 0.25 | 0.19 | 2.61 |
| (4) | H-1 | 0.50 | 0.17 | 2.52 |
| (5) | H-2 | 0.50 | 0.18 | 2.48 |
| (6) | H-2 | 1.0 | 0.17 | 2.41 |
| (7) | H-3 | 0.25 | 0.17 | 2.53 |
| (8) | H-4 | 0.25 | 0.19 | 2.58 |
| (9) | H-4 | 0.35 | 0.18 | 2.51 |
| (10) | H-8 | 0.25 | 0.17 | 2.55 |

As described above in detail, the photothermographic materials of the present invention each comprising, on a reflective support, at least one photosensitive silver halide, non-photosensitive organic silver salt, reducing agent for silver ions, binder and organic polyhalogen compound, particularly an organic polyhalogen compound represented by the formula (I) permits easy formation of a high quality image only by application of heat after image exposure. In particular, by the present invention, a reflective rapid access type photothermographic material can be provided.

This application is based on Japanese Patent application JP 2001-320550, filed Oct. 18, 2001, the entire content of which is hereby incorporated by reference, the same as if set forth at length.

What is claimed is:

1. A photothermographic material comprising:
a reflective support;
a photosensitive silver halide;
a non-photosensitive organic silver salt;
a reducing agent for silver ions;
a binder; and
an organic polyhalogen compound.

2. The photothermographic material according to claim 1, wherein the organic polyhalogen compound is represented by the following formula (H):
Q—(Y)ₙ—C(Z₁)(Z₂)X (H)
wherein, Q represents an alkyl, aryl or heterocyclic group, Y represents a divalent linking group, n stands for 0 or 1, Z₁ and Z₂ each represents a halogen atom, and X represents a hydrogen atom or an electron-withdrawing group.

3. The photothermographic material according to claim 1, wherein the reducing agent is represented by the following formula (R): 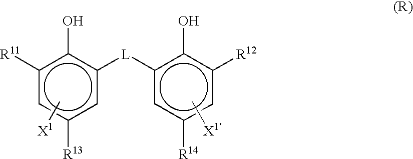
wherein, R¹¹ and R¹² each independently represents an alkyl group, R¹³ and R¹⁴ each independently represents an alkyl group, L represents an —S— or —CR¹⁵— group, in which R¹⁵ represents a hydrogen atom or an alkyl group, and X¹ and X^{1′} each independently represents a hydrogen atom or a group being capable of substituting to the benzene ring

4. The photothermographic material according to claim 3, wherein R¹¹ and R¹² each independently represents a secondary or tertiary alkyl group, R¹³ and R¹⁴ each independently represents an alkyl group, L represents a —CR¹⁵— group, in which R¹⁵ represents a hydrogen atom or an alkyl group.

5. The photothermographic material according to claim 1, further comprising, in one side defined by the support wherein the reducing agent exists, a compound capable of forming a hydrogen bond with an NH group or an OH group.

6. The photothermographic material according to claim 5, wherein the compound capable of forming a hydrogen bond is represented by the following formula (D): 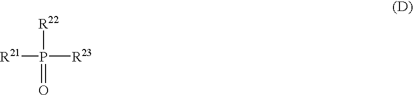
wherein, R²¹, R²² and R²³ each independently represents an alkyl, aryl, heterocyclic, alkoxy, aryloxy or amino group.

7. The photothermographic material of according to claim 1, further comprising, in one side defined by the support wherein the reducing agent exists, a hydrazine compound.

8. The photothermographic material according to claim 7, wherein the hydrazine compound is represented by the following formula (A):
R³¹—NHNHCONH—R³²
wherein, R³¹ represents an aryl or heterocyclic group and R³² represents an alkyl, aryl, heterocyclic or amino group.

9. The photothermographic material according to claim 1, further comprising, in one side defined by the support wherein the reducing agent exists, a heterocyclic compound comprising a mercapto group.

10. The photothermographic material of according to claim 1, wherein a coating quantity of silver is 1.0 g/m² or less.

11. The photothermographic material according to claim 1, wherein a coating quantity of the reducing agent is 2.0 mmol/m² or less.

12. A photothermographic material according to claims 1, wherein a heat developing time ranges from 1 to 12 seconds.
